(19) United States
(12) Patent Application Publication
(10) Pub. No.: US 2026/0230631 A1
(43) Pub. Date: Aug. 6, 2026

(54) DETERMINATION OF INTRA PREDICTION MODE FOR INDEXATION INTO NON-SEPARABLE TRANSFORM KERNELS

(71) Applicant: GUANGDONG OPPO MOBILE TELECOMMUNICATIONS CORP., LTD., Dongguan, Guangdong (CN)

(72) Inventors: Yue YU, Palo Alto, CA (US); Jonathan GAN, Palo Alto, CA (US); Haoping YU, Palo Alto, CA (US)

(73) Assignee: GUANGDONG OPPO MOBILE TELECOMMUNICATIONS CORP., LTD., Dongguan, Guangdong (CN)

(21) Appl. No.: 19/149,501

(22) PCT Filed: Jan. 8, 2024
(86) PCT No.: PCT/US2024/010718

§ 371 Date: Jul. 18, 2025

Related U.S. Application Data
(60) Provisional application No. 63/440,899, filed on Jan. 24, 2023.

(51) Int. Cl. H04N 19/159; H04N 19/12; H04N 19/184; H04N 19/61

(52) U.S. Cl. CPC H04N 19/159; H04N 19/12; H04N 19/184; H04N 19/61

(57) ABSTRACT

According to one aspect of the present disclosure, a method of decoding by a decoder is provided. The method may include parsing, by a processor, a bitstream. The method may include, in response to at least one non-separable transform being enabled for an intra prediction method, determining, by a processor, an intra prediction mode and at least one non-separable transform for use in decoding a coding unit (CU) of the bitstream. The at least one non-separable transform may be associated with a plurality of transform matrix sets. The method may include selecting, by the processor, a transform matrix from the plurality of transform matrix sets based on a bitstream index and the intra prediction mode. The method may include decoding, by the processor, the CU based on the intra prediction method and the transform matrix.

### CROSS-REFERENCE TO RELATED APPLICATIONS

This application claims the benefit of priority to U.S. Provisional Application No. 63/440,899, entitled “Determination of intra prediction mode for indexation into non-separable transform kernels” and filed on Jan. 24, 2023, which is incorporated by reference herein in its entirety.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), and moving picture expert group (MPEG) coding. Recent video coding techniques also continue to be evaluated in exploratory video coding models, such as the enhanced compression model (ECM).

### SUMMARY

According to one aspect of the present disclosure, a method of decoding by a decoder is provided. The method may include parsing, by a processor, a bitstream. The method may include, in response to at least one non-separable transform being enabled for an intra prediction method, determining, by a processor, an intra prediction mode and the at least one non-separable transform for use in decoding a coding unit (CU) of the bitstream. The at least one non-separable transform may be associated with a plurality of transform matrix sets. The method may include selecting, by the processor, a transform matrix from the plurality of transform matrix sets based on a bitstream index and the intra prediction mode. The method may include decoding, by the processor, the CU based on the intra prediction method and the transform matrix. The intra prediction mode may be determined in response to intra block copy (IBC), matrix weighted intra prediction (MIP), or intra template matching prediction (IntraTMP) being used for the CU. The at least one non-separable transform may include a low frequency non-separable secondary transform (LFNST) or a non-separable primary transform (NSPT).

According to another aspect of the present disclosure, a decoder is provided. The decoder may include a processor and memory storing instructions. The memory storing instructions, when executed by the processor, may cause the processor to parse a bitstream. In response to at least one non-separable transform being enabled for an intra prediction method, the memory storing instructions, when executed by the processor determine an intra prediction mode and the at least one non-separable transform for use in decoding a CU of the bitstream. The at least one non-separable transform may be associated with a plurality of transform matrix sets. The memory storing instructions, when executed by the processor, may cause the processor to select a transform matrix from the plurality of transform matrix sets based on a bitstream index and the intra prediction mode. The memory storing instructions, when executed by the processor, may cause the processor to decode the CU based on the intra prediction method and the transform matrix. The intra prediction mode may be determined in response to IBC, MIP, or IntraTMP. The at least one non-separable transform may include an LFNST or an NSPT.

According to a further aspect to the present disclosure, a non-transitory computer-readable medium storing instructions for a decoder is provided. The instructions, when executed by a processor, may cause the processor to parse a bitstream. The instructions, when executed by a processor, may cause the processor to, in response to at least one non-separable transform being enabled for an intra prediction method, determine an intra prediction mode and the at least one non-separable transform for use in decoding a CU of the bitstream. The at least one non-separable transform may be associated with a plurality of transform matrix sets. The instructions, when executed by a processor, may cause the processor to select a transform matrix from the plurality of transform matrix sets based on a bitstream index and the intra prediction mode. The instructions, when executed by a processor, may cause the processor to decode the CU based on the intra prediction method and the transform matrix. The intra prediction mode may be determined in response to IBC, MIP, or IntraTMP. The at least one non-separable transform may include an LFNST or a NSPT.

According to yet another aspect of the present disclosure, a method of encoding by an encoder is provided. The method may include, in response to at least one non-separable transform being enabled for an intra prediction method, determining, by the processor, an intra prediction mode and the at least one non-separable transform for use in encoding a CU to a bitstream, the at least one non-separable transform being associated with a plurality of transform matrix sets. The method may include selecting, by the processor, a transform matrix from the plurality of transform matrix sets based on a bitstream index and the intra prediction mode. The method may include encoding, by the processor, the CU based on the intra prediction method and the transform matrix. The intra prediction mode may be determined in response to one or more of IBC, MIP, or IntraTMP may be used for the CU. The at least one non-separable transform may include one or more of a LFNST or a NSPT.

According to yet a further aspect of the present disclosure, an encoder is provided. The encoder may include a processor and memory storing instructions. The memory storing instructions, when executed by the processor, cause the processor to, in response to at least one non-separable transform being enabled for an intra prediction method, determine an intra prediction mode and the at least one non-separable transform for use in encoding a CU to a bitstream. The at least one non-separable transform may be associated with a plurality of transform matrix sets. The memory storing instructions, when executed by the processor, cause the processor to select a transform matrix from the plurality of transform matrix sets based on a bitstream index and the intra prediction mode. The memory storing instructions, when executed by the processor, cause the processor to encode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

According to still another aspect of the present disclosure, a non-transitory computer-readable medium storing instructions is provided. The instructions, when executed by the processor, cause the processor to, in response to at least one non-separable transform being enabled for an intra prediction method, determine an intra prediction mode and the at least one non-separable transform for use in encoding a CU to a bitstream. The at least one non-separable transform may be associated with a plurality of transform matrix sets. The instructions, when executed by the processor, cause the processor to select a transform matrix from the plurality of transform matrix sets based on a bitstream index and the intra prediction mode. The instructions, when executed by the processor, cause the processor to encode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7A illustrates a low-frequency non-separable transform (LFNST) kernel for 4×N and N×4 block sizes in VVC, according to some embodiments of the present disclosure.

FIG. 7B illustrates an LFNST kernel for 8×N and N×8 block sizes in VVC, according to some embodiments of the present disclosure.

FIG. 8 illustrates various intra angular prediction modes, according to some embodiments of the present disclosure.

FIG. 9A illustrates an LFNST kernel for 4×N and N×4 block sizes in ECM, according to some embodiments of the present disclosure.

FIG. 9B illustrates an LFNST kernel for 8×N and N×8 block sizes in ECM, according to some embodiments of the present disclosure.

FIG. 9C illustrates an LFNST kernel 16×16 block size in ECM, according to some embodiments of the present disclosure.

FIG. 10 illustrates a matrix weighted intra prediction (MIP) mode for ECM, according to some embodiments of the present disclosure.

FIG. 11 illustrates an intra block copy (IBC) mode for ECM, according to some embodiments of the present disclosure.

FIG. 12 illustrates an intra template matching prediction (IntraTMP) mode for ECM, according to some embodiments of the present disclosure.

FIG. 13 illustrates a decoder-side intra mode derivation (DIMD) mode for ECM, according to some embodiments of the present disclosure.

FIG. 14 illustrates a template-based intra mode derivation (TIMD) mode for ECM, according to some embodiments of the present disclosure.

FIG. 15 illustrates a flowchart of an exemplary method of video decoding, according to some embodiments of the present disclosure.

FIG. 16 illustrates a flowchart of an exemplary method of video encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

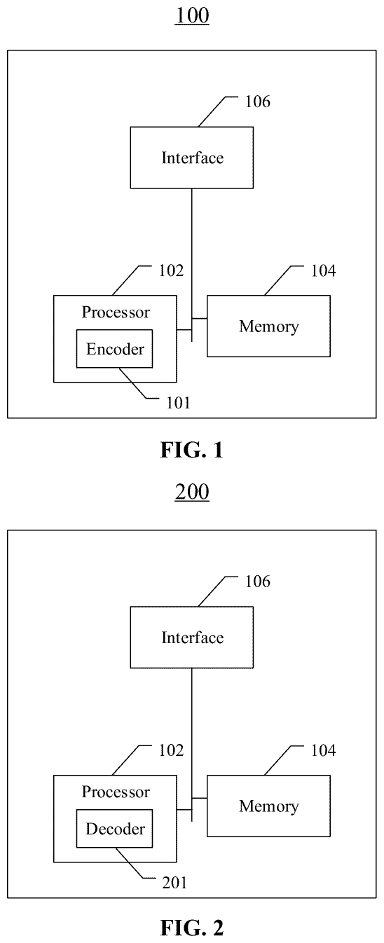

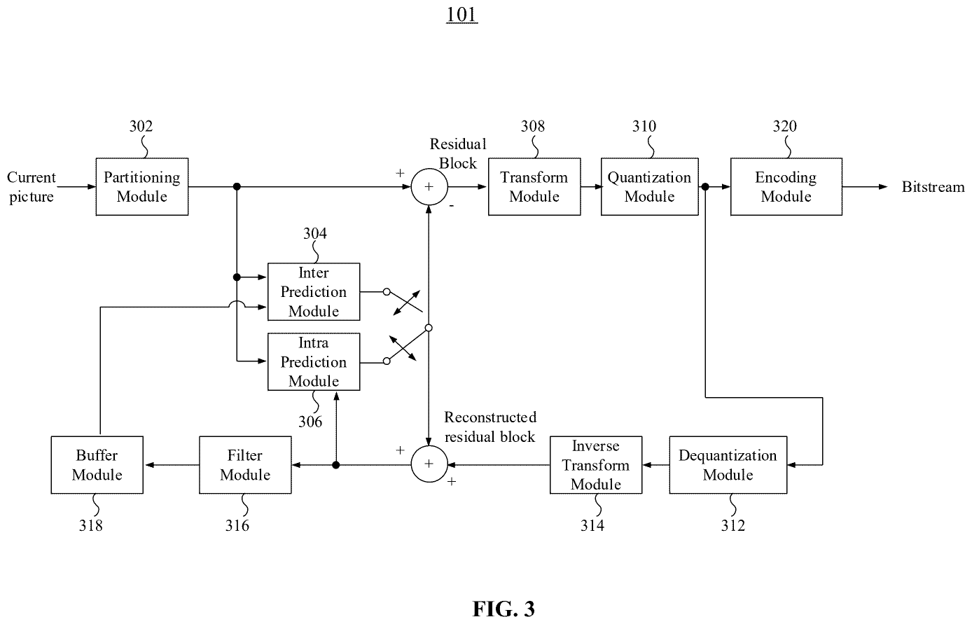

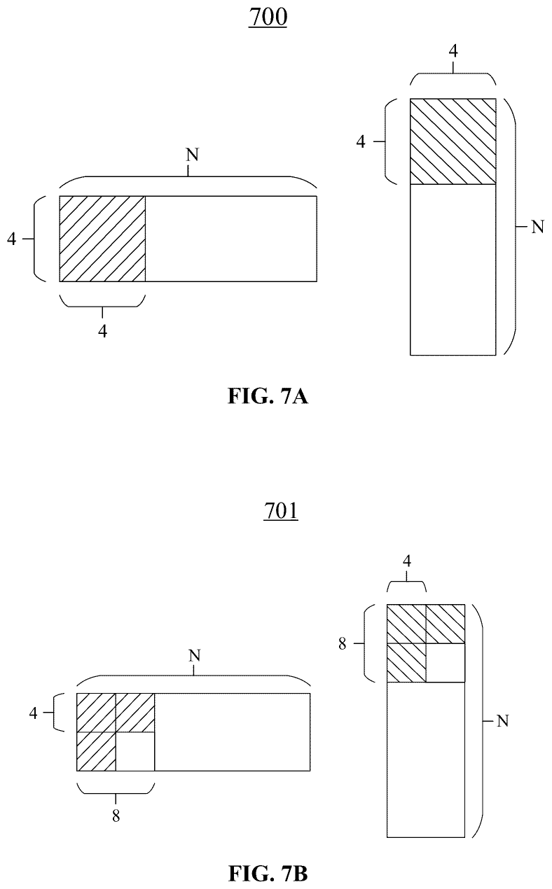

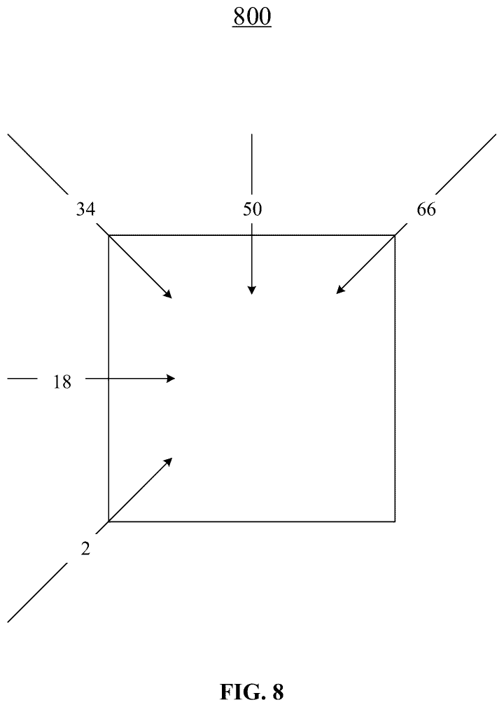

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 7 and 8, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 7 and 8, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 7 and 8, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one interface is shown in FIGS. 7 and 8, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples.

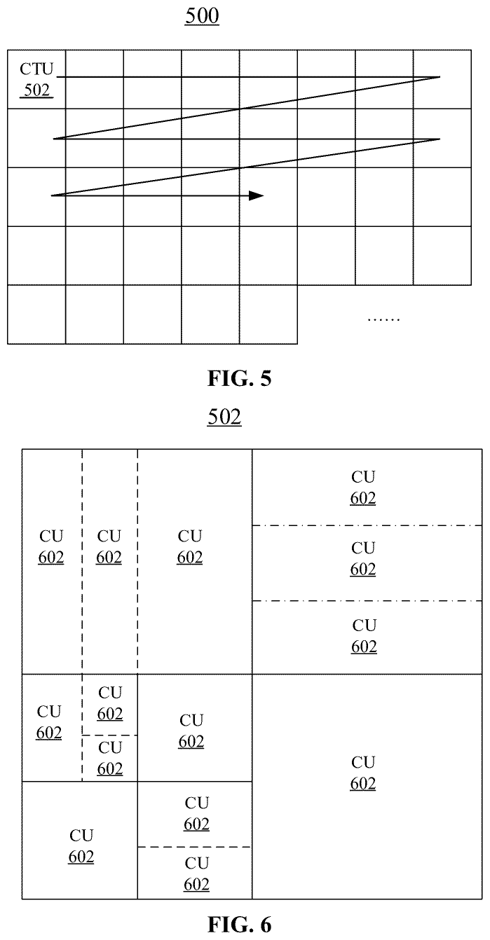

Similar to H.265/HEVC, H.266/VVC is a block-based hybrid spatial and temporal predictive coding scheme. As shown in FIG. 5, during encoding, an input picture 500 is first divided into square blocks—CTUs 502, by partitioning module 302. For example, CTUs 502 can be blocks of 128×128 pixels. As shown in FIG. 6, each CTU 502 in picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU 502 or be subdivisions of root CTU 502 as small as 4×4 blocks, according to some embodiments.

At this point, the partitioning module 302 may partition the picture into a plurality of coding units. Each coding unit may be further subdivided into one or more prediction units (PUs), and each prediction unit may be further subdivided into one or more transform units (TUs). However, in the general case each coding unit corresponds to one prediction unit and one transform unit of the same size.

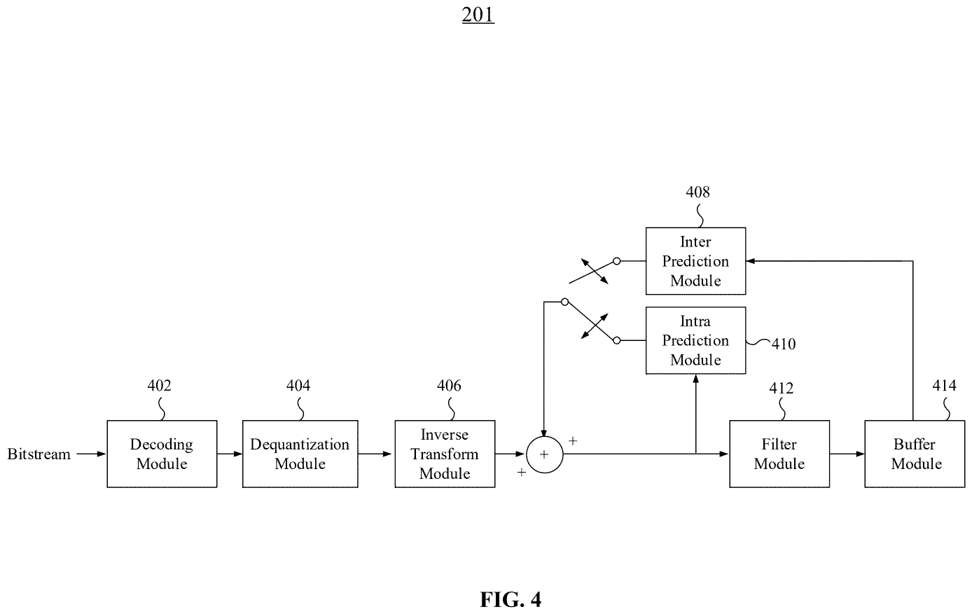

Referring to FIG. 4, inter prediction module 304 may be configured to perform inter prediction on a prediction unit, and intra prediction module 306 may be configured to perform intra prediction on the prediction unit. It may be determined whether to use inter prediction or intra prediction for the prediction unit, and determine specific information (e.g., intra prediction mode, motion vector, reference picture, etc.) according to each prediction method. Residual values in a residual block between the generated prediction block and the original block may be input into transform module 308. In addition, prediction mode information, motion vector information, and the like used for prediction may be encoded by encoding module 320 together with the quantization levels of transformed or non-transformed coefficients into the bitstream. It is understood that in certain encoding modes, transform and/or quantization may be skipped.

In some embodiments, inter prediction module 304 may predict a prediction unit based on information on at least one picture among previously coded pictures, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines adjacent or non-adjacent to the current block. When a block in the neighborhood of the current prediction unit is a block on which intra prediction has been performed and thus, the reference pixel is a pixel on which intra prediction has been performed, the reference pixel included in the block on which intra prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual block including a prediction unit that has performed prediction based on the prediction unit generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying a one-dimensional DCT to each row, resulting in intermediate transform coefficients, and then applying a one-dimensional DCT to each column of intermediate transform coefficients.

The benefit of applying a transform can be estimated by the transform coding gain, which is defined as the ratio of distortion between the distortion (D_{SQ}) if the residual samples are scalar quantized directly at a fixed bit rate, and the distortion (D_{TC}) if the transform coefficients x are scalar quantized at the same bit rate. Under assumptions that the residual is statistically a wide-sense stationary Gaussian white source, and the transform is orthonormal, the transform coding gain G_{TC} can be further interpreted as the ratio of the arithmetic mean of the transform coefficient variance

$${σ}_{x}^{2}$$

compared to the geometric mean of

$${σ}_{x}^{2} .$$

The transform coding gain G_{TC} may be described according to equation (1), shown below.

$${G}_{TC} = \frac{{D}_{SQ}}{{D}_{TC}} \approx \frac{\frac{1}{N} {\sum }_{i} {σ}_{{x}_{i}}^{2}}{{( {\prod }_{i} {σ}_{{x}_{i}}^{2} )}^{\frac{1}{N}}} . \qquad ( 1 )$$

Based on this interpretation, the transform coding gain, and correspondingly, the overall coding gain of the video coding system can be achieved when the resulting transform coefficients show energy compaction properties. In other words, the variance distribution is concentrated in a few transform coefficients compared to the original residual samples, which are likely to be evenly distributed.

The use of one-dimensional transforms applied separably in the horizontal and vertical directions scales well computationally with increasing block size. In the above example, the transform coefficients are obtained by a matrix implementation of the DCT, which results in (M+N) multiplications per sample. Even lower multiplications per sample can be achieved with “butterfly” factorizations, at the cost of slightly higher latency in the calculation. Separable transforms can optimally achieve energy compaction for spatial features along the Cartesian directions (e.g., vertical or horizontal). For example, a vertical edge is perfectly compacted by the vertical DCT. However, separable transforms cannot optimally exploit spatial features directed along non-Cartesian directions. In such cases, a well-designed non-separable transform may achieve more coding performance.

For instance, while a separable transform applies one-dimensional transforms in the horizontal and vertical directions separately, a two-dimensional non-separable transform is applied directly to a block of input samples. One desirable property of transforms is for the transform vectors to span the space of the input samples. This means any input vector (e.g., any combination of values of the input samples) can be represented by a weighted sum of the transform vectors. For a transform to be spanning, one necessary condition is that there must at least be as many transform vectors as the dimensionality of the input space, or in other words, the number of transform coefficients output is at least equal to the number of input samples. For example, the one-dimensional DCTs in VVC are spanning transforms. Then, for a spanning non-separable transform, if the block of input samples is an M×N residual, the transform will also output an M×N block of transform coefficients, which may be implemented by a matrix implementation of (M×N)×(M×N) multiplications.

To derive a non-separable transform that produces coding gain for a particular directional feature, the transform may be learned. For example, a representative set of residual blocks corresponding to the directional feature of interest may be grouped, and then the Karhunen-Loeve Transform (KLT) may be calculated from the covariance matrix of the set of residual blocks. The process may be repeated over K different sets of residual blocks. Then, in this example, an overall transform kernel is derived with dimensionality (M×N)×(M×N)×K.

There are two problems with spanning non-separable transforms, as described in this section. Firstly, the computation complexity is high. Because non-separable transforms are typically learned, they cannot generally be factorized. The matrix implementation of the spanning non-separable transform in the above example results in a complexity of M×N multiplications per sample. The second problem is that the transform kernel(s) occupy a large amount of storage in the encoder 101 and decoder 201. In the above example, a single kernel adaptable to K different directional features has (M×N)×(M×N)×K weights. This kernel can only be applied to residual blocks with size M×N. To allow the application of non-separable transform to multiple block sizes, a transform kernel must be learned for each block size.

In VVC, an LFNST tool was introduced with a number of modifications to address the problems described above for spanning non-separable transforms.

Firstly, while the LFNST tool applies to a wide range of block sizes, only two LFNST kernels are defined, according to a first modification. For instance, for blocks with size 4×N or N×4 (for N≥4), a smaller LFNST kernel is applied. For all larger block sizes (e.g., 8×8 or larger), a larger LFNST kernel is applied.

FIG. 7A illustrates a diagram 700 of an LFNST kernel used for 4×N and N×4 block sizes in VVC, according to some embodiments of the present disclosure. FIG. 7B illustrates a diagram 701 of LFNST kernel for 8×N and N×8 block sizes in VVC, according to some embodiments of the present disclosure.

FIGS. 7A and 7B illustrate the sample positions on which the LFNST acts. For example, from the encoder perspective and for 4×N or N×4 block sizes, the top left 4×4 sample positions (indicated by the shaded regions in FIG. 7A) are transformed by the small LFNST. The remaining sample positions (indicated by the white regions in FIG. 7A) are ignored, or “zeroed out”. From the decoder perspective, the inverse LFNST is applied to produce the top left 4×4 samples, while the remaining samples are filled in as zeros. A similar policy is applied for larger block sizes, where the LFNST acts on the 3 top left 4×4 blocks of sample positions (indicated by the shaded regions in FIG. 7B). The remaining sample positions are zeroed out.

As a consequence of the “zero out” policy, the LFNST is substantially reduced in size compared to a full size transform applying to all sample positions. However, it is inherently lossy and cannot restore the values at sample positions which are ignored by the LFNST. Such loss would be too large for the LFNST tool to be useful if it were applied directly to the residual samples. However, the LFNST is called a secondary transform because it is applied after the separable DCT at the encoder has already been performed, acting on primary transform coefficients to produce secondary transform coefficients. In other words, the DCT may be considered to be a primary transform. According to embodiments of the present disclosure, the left-most sample positions in a block of primary transform coefficients correspond to the horizontal low frequencies of the DCT, while the top-most sample positions correspond to the vertical low frequencies of the DCT. By preferentially transforming and reconstructing at decoder 201, the top-left sample positions, the LFNST is able to reconstruct the low-frequency information from the original residual. As described previously, transforms produce coding gain due to their energy compaction properties, and it has been well established that the variance (energy) of a camera-captured image and video signals is predominantly concentrated in the low frequency DCT coefficients. Therefore, while “zero out” prevents the LFNST from reconstructing an arbitrary residual block losslessly, in practice, the loss can be minimal for most classes of image and video signals.

A second modification is that for both the small and large LFNST kernels, the transform applied is not a spanning transform. From the perspective of encoder 101, the number of output (secondary transform) coefficients is less than the number of input (primary transform) coefficients. For example, the smaller LFNST kernel takes as input 4×4=16 primary transform coefficients, but produces only 8 output secondary transform coefficients. The larger LFNST kernel takes 3×4×4=48 input primary transform coefficients and outputs 8 secondary transform coefficients. The use of a non-spanning transform introduces further reconstruction loss. However, this loss can be traded off in a controlled manner against the achieved complexity reduction. A spanning non-separable transform may first be designed by the KLT method described above. By following this method, the basis vectors of the transform correspond to eigenvectors of the covariance matrix calculated from a representative set of residual blocks. These eigenvectors may be ranked in importance by their corresponding eigenvalues, with the most important eigenvectors selected to construct a non-spanning non-separable transform. For example, the 8 eigenvectors with the largest eigenvalues may be selected to form a non-spanning transform for the smaller LFNST kernel.

In summary, the two modifications described above significantly reduce the complexity of the LFNST kernel, as compared to the spanning non-separable transform. For smaller blocks, the use of the smaller LFNST kernel reduces the potential complexity from (4×N)×(4×N) multiplications per transform block (for N≥4), down to 16×8 multiplications. For larger blocks, the use of the larger LFNST kernel reduces the potential complexity from (8×N)×(8×N) multiplications per transform block (for N≥8), down to 48×8 multiplications.

The LFNST kernels do not include only one transform matrix. To achieve better coding gain over a variety of image and video signals, multiple transform matrices are learned. The number of different transform matrices is the product of the 3^{rd} and 4^{th} dimensions of the LFNST kernel: the smaller LFNST kernel has a dimensionality of 16×8×2×4, and the larger LFNST kernel has a dimensionality of 48×8×2×4. The LFNST kernel is expressed with two additional dimensions because the particular transform matrix for a transform block is selected by a mixture of explicit signaling and implicit selection.

Explicit signaling is performed by an LFNST index signaled in the bitstream that may take the value 0, 1, or 2, where 0 indicates that the LFNST is not used for the transform block, while values 1 or 2 indicate selection in the 3^{rd} dimension of the LFNST kernel. The drawbacks of potential reconstruction loss due to the zero-out and non-spanning simplifications are ameliorated by the explicit signaling mechanism. While the use of LFNST would result in excessive reconstruction loss for a transform block, the LFNST tool can be disabled by signaling an LFNST index of 0.

Implicit selection is enabled by restricting the LFNST only to coding units that use intra prediction. Intra prediction produces a prediction block for the coding unit from adjacent neighboring reference samples to the top and left of the current block. The particular method of constructing the prediction block is signaled in the bitstream by an intra prediction mode. Simple methods of intra prediction include taking the average of the reference samples (“DC” mode), or constructing an affine interpolation between some reference samples (“planar” mode). However, the majority of the intra prediction modes are reserved for signaling intra angular directions, where the prediction block is constructed by assuming the reference sample values are replicated along a particular direction. When an intra angular direction is used, it may be a strong hint for the directional characteristics of the residual block. Implicit selection of an LFNST transform is performed by mapping the intra prediction mode to one of 4 possible values of a “transform set index”, which is used to index into the 4^{th} dimension of the LFNST kernel. The mapping used in VVC is shown in Table 1.

TABLE 1
Mapping from intra prediction mode to LFNST transform set index

| Intra prediction mode | lfnstTrSetIdx |
|---|---|
| predModeIntra < 0 | 1 |
| 0 <= predModeIntra <= 1 | 0 |
| 2 <= predModeIntra <= 12 | 1 |
| 13 <= predModeIntra <= 23 | 2 |
| 24 <= predModeIntra <= 44 | 3 |
| 45 <= predModeIntra <= 55 | 2 |
| 56 <= predModeIntra <= 80 | 1 |

Intra prediction modes 0 and 1 correspond to intra prediction planar mode and intra DC prediction mode, respectively. These modes are handled as a special case by mapping to the transform set index 0. Otherwise, the remaining intra prediction modes correspond to intra angular directions 800, which are partially shown in FIG. 8. Intra prediction mode 2 corresponds to a diagonal intra angular prediction from the bottom-left. Increasing intra prediction mode numbering corresponds to clockwise rotation of the intra prediction direction, with intra prediction mode 34 corresponding to diagonal intra angular prediction from the top-left, and intra prediction mode 66 corresponding to diagonal intra angular prediction from the top-right.

For intra prediction modes greater than 34, which correspond to intra angular prediction directions clockwise of diagonal from the top-left, the selected LFNST transform matrix is applied in a transpose manner for the primary transform coefficients. In one implementation, this may be performed by scanning the primary transform coefficients in a transpose direction before applying the LFNST transform. For example, from the perspective of encoder 101, if a current block is predicted by intra prediction mode 2, then the primary transform coefficients may be rearranged from their two-dimensional pattern in the block to a one-dimensional vector by a row-major scan, before applying a selected LFNST transform matrix T. Then, for this example, if the current block is instead predicted by intra prediction mode 66, and the same signaled LFNST index is used, the primary transform coefficients would instead be rearranged to a one-dimensional vector by column-major scan before applying the same LFNST transform matrix T. In another implementation, the same current block with intra prediction mode 66 can be equivalently transformed by still performing a row-major scan over the primary transform coefficients, but instead rearranging the rows of the transform matrix T.

More generally, the application of the LFNST transform matrix may be described as follows. Let the primary transform coefficient located at row y, column x be denoted as p_{x,y}, and let the LFNST transform matrix T have dimensions A×B, where A is the number of secondary transform coefficients, and B is the number of primary transform coefficients that are not zeroed out. Then, for intra prediction modes <=34, an arbitrary scan order through the primary transform coefficients p_{x,y} to construct a one-dimensional vector P may be defined by equation (2), shown below.

$$P = \{ {p}_{{x}_{0} , {y}_{0}} , {p}_{{x}_{1} , {y}_{1}} , {p}_{{x}_{2} , {y}_{2}} , … {p}_{{x}_{B - 1} , {y}_{B - 1}} \} . \qquad ( 2 )$$

For intra prediction modes greater than 34, P is instead constructed by the transposed scan order as defined by equation (3), shown below.

$$P = \{ {p}_{{y}_{0} , {x}_{0}} , {p}_{{y}_{1} , {x}_{1}} , {p}_{{y}_{2} , {x}_{2}} , … {p}_{{y}_{B - 1} , {x}_{B - 1}} \} . \qquad ( 3 )$$

The forward LFNST transform may be understood as the matrix multiplication S=TP, where S is a one-dimensional vector of secondary transform coefficients. In practice, the transform is implemented as S=n(TP) since all multiplications are implemented in integer arithmetic, and n(⋅) represents normalization operations necessary for the integerized LFNST to approximate the ideal transform expressed in floating point. Secondary transform coefficients are written back to the transform block in a forward diagonal scan order. Following the same notation as introduced above, and the convention that the (0,0) location corresponds to “low frequency” or “DC” in the conventional DCT, the scan order s may be defined according to equation (4), shown below.

$$S = \{ {s}_{0 , 0} , {s}_{0 , 1} , {s}_{1 , 0} , {s}_{0 , 2} , {s}_{1 , 1} , {s}_{2 , 0} , {s}_{0 , 3} , {s}_{1 , 2} , {s}_{2 , 1} , {s}_{3 , 0} , … \} . \qquad ( 4 )$$

From the perspective of decoder 201, the inverse LFNST transform may be expressed as the matrix multiplication P=n(T^{T}S), or in other words, the inverse transform is performed by the transpose of the matrix T.

Transposition of the primary transform coefficients for intra prediction modes greater than 34 allows the same LFNST transform matrix to be shared for intra angular prediction directions that are symmetric.

In post-VVC exploratory activity, an extension to the LFNST has been proposed and integrated into an ECM. The LFNST tool in ECM relaxes some of the complexity reductions imposed on the original LFNST tool adopted in VVC to achieve enhanced coding gain.

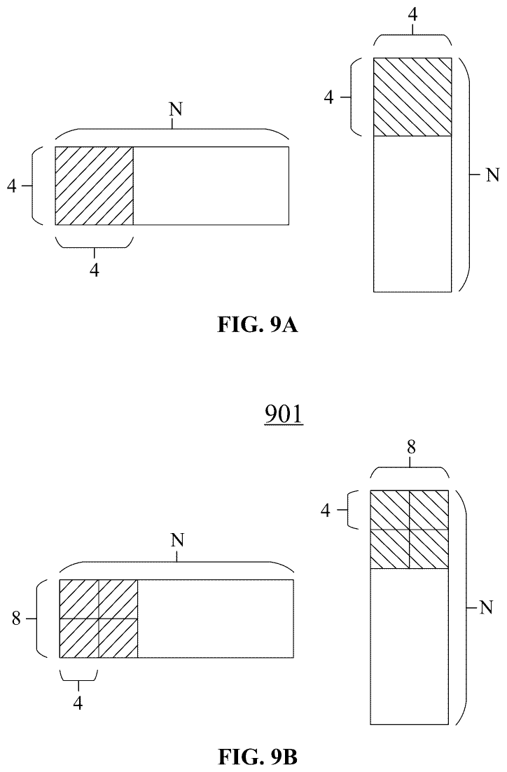

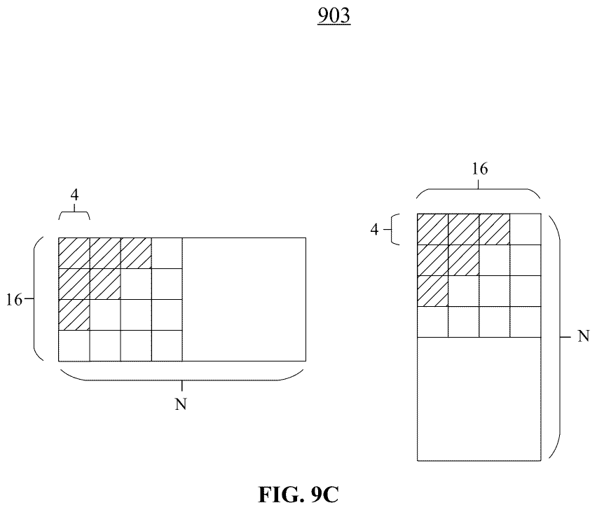

ECM has three LFNST kernels. Similar to the LFNST tool in VVC, in most cases, a significant portion of the transform block is zeroed out, as depicted in FIGS. 9A-9C. For instance, FIG. 9A illustrates a diagram 900 of an LFNST kernel for 4×N and N×4 block sizes in ECM, according to some embodiments of the present disclosure. FIG. 9B illustrates a diagram 901 of an LFNST kernel for 8×N and N×8 block sizes in ECM, according to some embodiments of the present disclosure. FIG. 9C illustrates a diagram 903 of an LFNST kernel 16×16 block size in ECM, according to some embodiments of the present disclosure.

In FIGS. 9A-9C, the shaded regions indicate the primary transform coefficient positions on which the LFNST in ECM acts, while the white regions indicate which transform coefficient positions are zeroed out. For blocks with size 4×N or N×4 (where N≥4), a small LFNST kernel is used on the top left 4×4 primary transform coefficients. For blocks with size 8×N or N×8 (where N≥8), a medium LFNST kernel is used on the 4 top left 4×4 blocks of primary transform coefficients. For 16×16 or larger blocks, a large LFNST kernel is used on the 6 top left 4×4 blocks of primary transform coefficients.

The size of the LFNST kernels in ECM are 16×16×3×35 for the small LFNST kernel, 64×32×3×35 for the medium LFNST kernel, and 96×32×3×35 for the large LFNST kernel. Compared to the LFNST tool in VVC, the range of signalled LFNST indices is increased from 2 to 3, and the number of LFNST transform sets is increased from 4 to 35. This means there are 35 LFNST transform matrices per each of the 3 indices. The mapping from intra prediction mode to LFNST transform set index is shown in Table 2. Similar to the LFNST tool in VVC, when the intra prediction mode is greater than 34, then the primary transform coefficients are transposed.

TABLE 2
Mapping from intra prediction mode
to LFNST transform set index in ECM

| Intra prediction mode | lfnstTrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

The complexity burden of the LFNST tool may be evaluated in three ways. Firstly, there is an additional storage burden imposed on decoder 201 because it must store the LFNST kernels. Secondly, the worst-case multiplications per sample that decoder 201 must perform if the LFNST tool is exercised. Thirdly, the additional multiplications per sample that encoder 101 uses if a full search over the LFNST tool is performed. By all three measures, the extended LFNST proposed in ECM is more complex than the LFNST of VVC. However, the worst-case decoder complexity, in terms of the total number of multiplications per sample, may still be less than the worst-case decoder complexity of other transform options.

For a matrix multiplication implementation of the DCT applied separably to an M×N size transform, the multiplications per sample are (M+N). Therefore, the worst-case complexity occurs for the largest value of (M+N). In practice, the complexity may be reduced by alternative implementations of the DCT, such as butterfly factorisation, but it is still convenient to assess the complexity of a matrix multiplication implementation. The separable DCT has been extended in ECM so that the largest transform is the 128-point DCT. Then, the worst-case complexity for the separable DCT is potentially 128+128=256 multiplications per sample.

The worst-case decoder complexity of the LFNST in ECM may be assessed by considering a number of different block sizes. For a fair comparison, the assessment includes the cost of performing the primary transform. For a 4×4 block, the primary transform includes a 4+4=8 multiplications per sample. The LFNST includes a 16×16 matrix multiplication, which is 16 multiplications per sample. Therefore, the overall cost of the LFNST for 4×4 blocks is 24 multiplications per sample.

For a 4×8 block, a naïve implementation of the DCT primary transform would usually require 8 4×4 transforms along the short dimension and 4 8×8 transforms along the long dimension, resulting in an overall 4+8=12 multiplications per sample. However, because the LFNST only reconstructs non-zero coefficient values in the top-left 4×4 block of primary transform coefficient positions, an optimized decoder would be able to take advantage by only performing 4 4×4 transforms along the short dimension, then 4 4×8 transforms along the long dimension, resulting in an overall 2+4=6 multiplications per sample. As the order of the separable transforms is generally fixed, in the worst-case scenario, decoder 201 may perform 4 4×8 transforms along the long dimension first. Then, decoder 201 may perform 8 4×4 transforms along the short dimension. This results in 4+4=8 multiplications per sample. The LFNST is still a 16×16 matrix multiplication whose cost is amortized over a larger block, resulting in 8 multiplications per sample. Then, the worst-case cost of the LFNST for 4×8 blocks is 16 multiplications per sample. The same principles apply generally for 4×N or N×4 block sizes. Therefore, the multiplications per sample for 4×N or N×4 blocks will always be less than or equal to the multiplications per sample for 4×4 blocks.

For an 8×8 block, the primary transform consists of 8+8=16 multiplications per sample. The LFNST consists of a 64×32 matrix multiplication, which is 32 multiplications per sample. Then, the overall cost of the LFNST for 8×8 blocks is 48 multiplications per sample.

For an 8×16 block, it is again assumed that decoder 201 takes advantage of the zero-out properties of LFNST reconstruction. Only the top left 8×8 block of primary transform coefficient positions is non-zero. Decoder 201 may take advantage of this by only performing 8 8×8 transforms along the short dimension. Then, decoder 201 may perform 8 8×16 transforms along the long dimension. This results in an overall 4+8=12 multiplications per sample. Alternatively, decoder 201 may perform 8 8×16 transforms along the long dimension first. Then, decoder 201 may perform 16 8×8 transforms along the short dimension. This may result in 8+8=16 multiplications per sample. The LFNST adds another (64×32)/(8×16)=16 multiplications per sample, resulting in an overall worst-case complexity of 32 multiplications per sample. As before, the multiplications per sample for 8×N or N×8 blocks are always less than or equal to the multiplications per sample for 8×8 blocks.

For a 16×16 block, the zero-out properties of LFNST reconstruction mean that only six 4×4 blocks of primary transform coefficients in the pattern (as shown in FIG. 9C) have non-zero values. For simplicity, let us assume a more relaxed pattern where the top-left 12×12 block of primary transform positions may have non-zero values. First, decoder may take advantage of this by only performing 12 12×16 transforms in one dimension. Then, decoder 201 may perform 16 12×16 transforms in the second dimension, which includes 9+12=21 multiplications per sample. The LFNST includes (96×32)/(16×16)=12 multiplications per sample, resulting in an overall complexity of 33 multiplications per sample.

For an M×N block where M, N≥16, decoder 201 may first perform 12 12×M transforms in one dimension. Then, decoder 201 may perform M 12×N transforms in the second dimension, resulting in (12×12)/N+12 multiplications per sample to perform the separable DCT. Then, the worst-case complexity occurs for the smallest value of N=16, which is 21 multiplications per sample and equal to the complexity for 16×16 blocks. The LFNST adds another (96×32)/(M×N) multiplications per sample, which is always less than or equal to the multiplications per sample for 16×16 blocks. Therefore, the overall complexity of the LFNST in ECM for larger M×N block sizes is always equal to or less than the multiplications per sample for 16×16 blocks.

After assessing the decoder complexity of the LFNST in ECM exhaustively across different block sizes, it is shown that the worst-case complexity is 48 multiplications per sample (occurring in the case of 8×8 blocks). This worst-case complexity includes the cost of performing the separable DCT with matrix multiplication implementation, but due to optimizations possible from LFNST zero-out, it is significantly less than the worst-case complexity of performing the separable DCT alone (which is assessed as 256 multiplications per sample). If assuming a more practical implementation of the separable DCT with butterfly factorization, then the worst-case complexity of the LFNST still occurs for 8×8 blocks, with a cost of 32 multiplication per sample from the LFNST, plus the cost of the butterfly DCT. In such case, the LFNST may be the worst case compared with the cost of butterfly DCT applied separably to 256×256 size blocks.

As seen above, the use of non-separable secondary transform allows significant complexity reductions due to the use of zero-out on selected primary transform coefficient regions. However, further coding may be possible with a non-separable primary transform (NSPT). An initial study on non-separable primary transforms found that significant gains (3.43% average rate reduction by the Bjontegaard metric) could be achieved, although the transforms implemented were complex, and the kernel weights were obtained by overfitting to the test data set.

A practical implementation of NSPT is proposed. For instance, the NSPT may only be applied to a small set of block sizes: 4×4, 4×8, 8×4, and 8×8. For these block sizes, the NSPT replaces both primary transform and LFNST. As with the LFNST, the NSPT kernels are trained, with a selection of an appropriate matrix for a particular block guided by both a signalled index and implicit selection through the intra prediction mode. Four NSPT kernels are proposed. For 4×4 blocks, a small NSPT kernel with dimensions 16×16×3×35 is used. For 4×8 and 8×4 blocks, medium NSPT kernels with dimensions of 32×20×3×35 are used. For 8×8 blocks, a large NSPT kernel with dimensions 64×32×3×35 is used.

According to the present disclosure, defined zero-out may be defined as a reduction in the input dimension of the transform kernel, which in the notation of the transform kernel dimensions of this disclosure corresponds to the first dimension. A reduction in the input dimension of the forward transform is equivalent to a reduction of the support for the transform. For example, the LFNST zero-out corresponds to a reduction of the number of DCT primary transform coefficients that the forward LFNST acts on to produce secondary transform coefficients. In the proposed NSPT, the transform acts directly on the residual coefficients, so a reduction of the first dimension of an NSPT kernel includes a reduction in the number of residual coefficients that the forward NSPT acts on to produce primary transform coefficients. In the known proposal mentioned above, the size of each NSPT kernel's first dimension is always equal to the number of samples in the block, so zero-out, according to the definition in this disclosure, is not used. However, in this known proposal, zero-out is instead defined as a reduction in the output dimension of the transform kernel, which in the notation of transform kernel dimensions in this disclosure is the second dimension. Such definition is not ambiguous in that proposal since no reduction is ever performed on the input side of the NSPT kernel, and gives an example of the term “zero-out” being used more generally. However, for consistency and clarity within this disclosure, “zero-out” is defined to describing a reduction in the input dimension of a transform kernel, while labeling a reduction of the output dimension as a non-spanning, or lossy transform. For the medium and large NSPT kernels the second dimension is smaller than the first dimension, meaning that the NSPT in these cases is a lossy transform.

As with the LFNST, an NSPT index is signaled in the bitstream that may take the value 0, 1, 2, or 3, where 0 indicates that the NSPT is not used for the transform block, while values 1-3 indicate selection within the corresponding NSPT kernel along the 3^{rd} dimension. Selection along the 4^{th} dimension of the NSPT kernel is determined by mapping from the intra prediction mode as shown in Table 3, in the same manner as for the extended LFNST in ECM. As with the LFNST, when the intra prediction mode is greater than 34 (which means the intra angular direction is clockwise of the diagonal top-left direction), the input to the transform is transposed. However, for the NSPT, the input is composed of residual coefficients, not primary transform coefficients.

TABLE 3
Mapping from intra prediction mode
to NSPT transform set index in ECM

| Intra prediction mode | nsptTrSetIdx |
|---|---|
| predModeIntra < 0 | 2 |
| 0 <= predModeIntra <= 34 | predModeIntra |
| 35 <= predModeIntra <= 66 | 68 - predModeIntra |
| 67 <= predModeIntra <= 80 | 2 |

For an M×N shape residual block, and when the intra prediction mode is less than or equal to 34, let the residual sample located at row y, column x be denoted r_{x,y}, and let an NSPT transform matrix T selected from the NSPT kernel for M×N shaped blocks have dimensions A×B, where A is the number of primary transform coefficients, and B=M×N is the number of residual samples in the block. Then, an arbitrary scan order through the residual samples to construct a one-dimensional vector R may be defined according to equation (5), shown below.

$$R = \{ {r}_{{x}_{0} , {y}_{0}} , {r}_{{x}_{1} , {y}_{1}} , {r}_{{x}_{2} , {y}_{2}} , … {r}_{{x}_{B - 1} , {y}_{B - 1}} \} . \qquad ( 5 )$$

For intra prediction modes greater than 34, R is instead constructed by the transposed scan order, according to equation (6).

$$R = \{ {r}_{{y}_{0} , {x}_{0}} , {r}_{{y}_{1} , {x}_{1}} , {r}_{{y}_{2} , {x}_{2}} , … {r}_{{y}_{B - 1} , {x}_{B - 1}} \} . \qquad ( 6 )$$

Additionally, when the intra prediction mode is greater than 34, the NSPT transform matrix T is selected instead from the NSPT kernel for N×M shaped blocks. For square block shapes, this is the same kernel. However, in the case of 4×8 or 8×4 block sizes, the transform matrix is selected from a different NSPT kernel.

The forward NSPT transform may be implemented as P=n(TR), where P is a one-dimensional vector of NSPT transform coefficients, and no denotes normalization operations necessary for the integerized NSPT to approximate the ideal transform expressed in floating point. Transform coefficients are written back to the transform block in a forward diagonal scan order. Following the same notation as introduced above, and the convention that the (0,0) location corresponds to “low frequency” or “DC” in the conventional DCT, the scan order is described according to equation (7).

$$P = \{ {p}_{0 , 0} , {p}_{0 , 1} , {p}_{1 , 0} , {p}_{0 , 2} , {p}_{1 , 1} , {p}_{2 , 0} , {p}_{0 , 3} , {p}_{1 , 2} , {p}_{2 , 1} , {p}_{3 , 0} , … \} . \qquad ( 7 )$$

From the perspective of decoder 201, the inverse NSPT transform may be expressed as the matrix multiplication R=n(T^{T}P), or in other words, the inverse transform is performed by the transpose of the matrix T.

The kernel sizes and the block sizes for which NSPT is enabled are designed so that the NSPT may be practically implemented. This may be confirmed by comparing the complexity of the NSPT at each block size against the complexity of the corresponding LFNST it replaces. For 4×4 blocks, the NSPT has a complexity of 16 multiplications per sample compared with the LFNST complexity of 24 multiplications per sample. For 4×8 and 8×4 blocks, the NSPT has a complexity of 20 multiplications per sample compared with the LFNST complexity of 16 multiplications per sample. For 8×8 blocks, the NSPT has a complexity of 32 multiplications per sample compared with the LFNST complexity of 48 multiplications per sample. In some cases, the NSPT has lower complexity than the LFNST it replaces, while in other cases, the NSPT is more complex. Overall, the NSPT complexity is designed so that the burden on the encoder is not increased. From the perspective of decoder 201, the worst-case complexity of the NSPT at 32 multiplications per sample is still less than the worst-case complexity of all transform options the decoder must support. Therefore, worst-case decoder complexity is not increased.

To improve the coding performance of the NSPT tool, an extension to larger block sizes is contemplated. The NSPT may be extended beyond the original set of block sizes 4×4, 4×8, 8×4, and 8×8. The NSPT is additionally applied to, and replaces the LFNST, for block sizes 4×16, 16×4, 8×16, and 16×8. For block sizes 4×16 and 16×4, NSPT kernels with dimensions of 64×24×3×35 are used. For block sizes 8×16 and 16×8, NSPT kernels with dimensions of 128×40×3×35 are used.

As shown above in Tables 1, 2, and 3 above, both the LFNST and NSPT tools use a mapping from the intra prediction mode to a transform set index so that the selection of a particular transform can be guided by the directionality of the intra prediction mode. This mapping supports default transform selection when simple intra prediction modes such as planar (numbered 0) or DC (numbered 1) are used. However, most of the benefit is obtained due to mapping from intra angular prediction modes numbered from 2 to 66, and wide-angle intra angular prediction modes numbered less than 0 or greater than 66.

Beyond the intra prediction modes described above, VVC includes several more intra prediction tools, including intra block copy (IBC) and matrix weighted intra prediction (MIP). Neither IBC nor MIP have any relation to a particular intra angular prediction direction, so attempting to combine either of these prediction methods with LFNST or NSPT requires explicit determination of an intra prediction mode for the purposes of selecting the LFNST or NSPT matrix. In VVC, LFNST is disabled if IBC is selected, or MIP is selected for small CU sizes. For large CU sizes, LFNST is enabled for MIP with the intra prediction mode set to planar for the purposes of selecting the LFNST matrix.

The ECM exploratory activity has included many more intra prediction tools, such as intra template matching prediction (IntraTMP), decoder-side intra mode derivation (DIMD), and template-based intra mode derivation (TIMD).

MIP is an intra prediction method that uses trained weights to produce a predictor block for a CU. Like the intra angular prediction modes, MIP also uses the above and left neighboring reference samples to produce a prediction for the current CU. Intra angular prediction produces a prediction block by replicating the reference samples along the direction of the angular mode, which results in relatively simplistic prediction. In contrast, MIP takes advantage of offline training and greater freedom in how the prediction block is generated from the reference samples, such that MIP is capable of predicting textures and patterns.

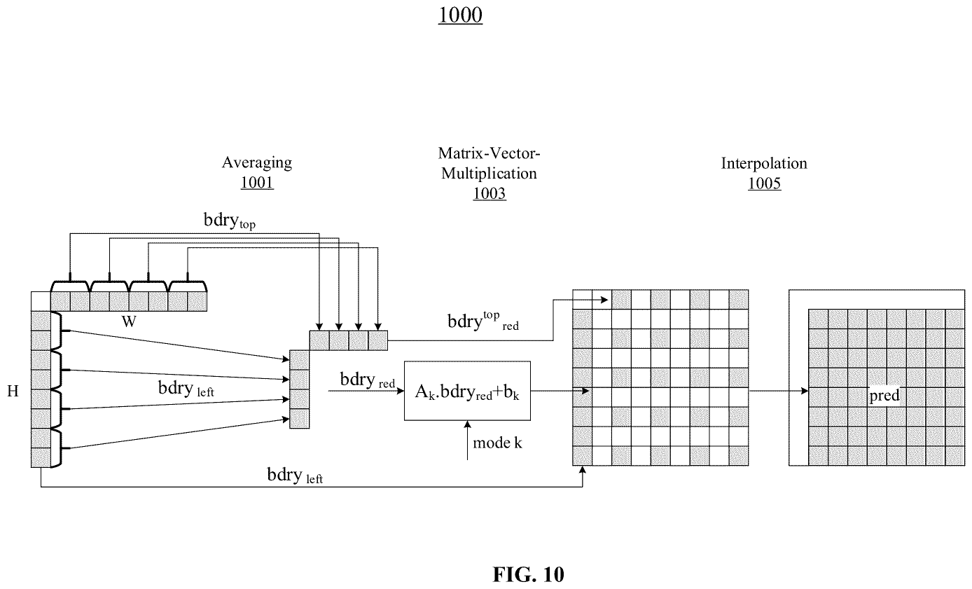

To limit implementation complexity, MIP operations 1000 have averaging and interpolation steps, which are shown in FIG. 10. In the averaging operation (at 1001), the reference samples are averaged to produce at most eight downsampled reference samples bdry_{red}. In the matrix-vector multiplication (at 1003), considering only the cases when MIP is applied to large block sizes, a reduced prediction signal pred_{red} of dimension 8×8 is produced based on equation (8).

$$p r e {d}_{r e d} = {A}_{k} b d r {y}_{r e d} + {b}_{k} , \qquad ( 8 )$$

where Aₖ is a matrix with dimensions 64×8, and bₖ is an offset vector with length 64.

In the interpolation operation (at 1005), linear interpolation is used to expand the 8×8 reduced prediction signal to the full dimensions of the CU.

The specific matrix Aₖ and offset bₖ are selected from a set by signaling the value k in the bitstream as a MIP syntax element modeId. The MIP matrices are also reused in a transposed form when an MIP isTransposed flag is signaled.

In total, there are three sets of MIP matrices and offset vectors to cover a range of block sizes. The set S₀ includes 16 matrices

$${A}_{0}^{i} ,$$

iϵ{0, . . . , 15}, each of which has dimension 16×4 and 16 offset vectors

$${b}_{0}^{i} ,$$

iϵ{0, . . . , 16} each of size 16. Matrices and offset vectors of that set are used for blocks of size 4×4. The set S₁ includes 8 matrices

$${A}_{1}^{i} ,$$

i ϵ{0, . . . , 7}, each of which has dimension 16×8 and 8 offset vectors

$${b}_{1}^{i} ,$$

i ϵ{0, . . . , 7} each of size 16. The set S₂ (which corresponds to the above example) includes 6 matrices

$${A}_{2}^{i} ,$$

iϵ{0, . . . , 5}, each of which has dimension 64×8 and 6 offset vectors

$${b}_{2}^{i} ,$$

i ϵ{0, . . . , 5} of size 64.

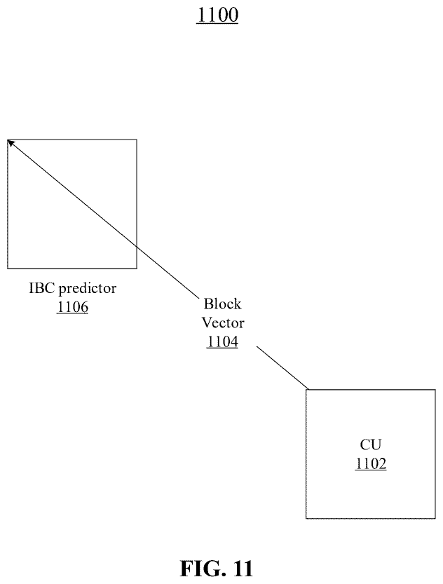

FIG. 11 illustrates a diagram 1100 of an IBC method, according to some embodiments of the present disclosure. Referring to FIG. 11, when a CU 1102 is predicted by intra block copy mode, a block vector 1104 is signaled to indicate which block within the same picture will be copied to serve as a predictor for the current block. Signaling of block vector 1104 may be performed by signaling a block vector difference (BVD) in the bitstream, such that decoder 201 may determine block vector 1104 by adding the BVD to a block vector predictor. Alternatively, if a block vector from a previous CU is an exact match for the current block vector (block vector 1104), it may be signalled by a merge flag. Regardless of the signalling mechanism, block vector 1104 points at a location within the same picture to indicate a block of samples equal in size to the current CU that is used as an IBC predictor block 1106 for the current CU (CU 1102). Some restrictions may apply to block vector 1104, as it must point at a location in the current picture that has been decoded before the current CU.

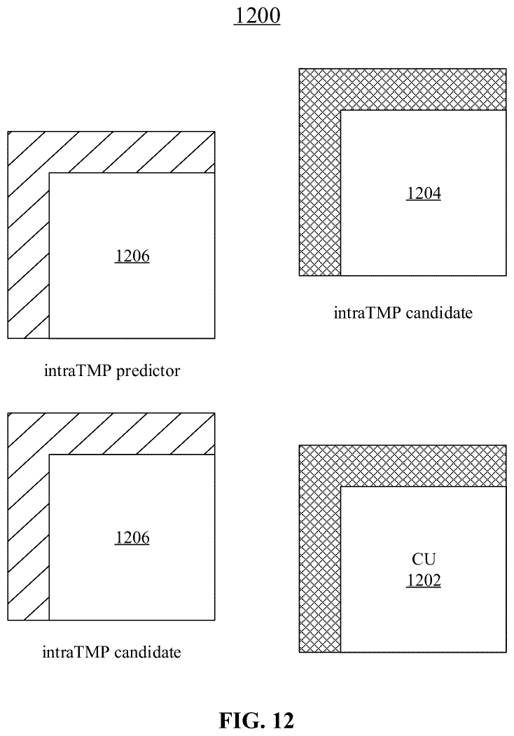

FIG. 12 illustrates a diagram 1200 of an intra template matching prediction (IntraTMP) method, according to some embodiments of the present disclosure. Referring to FIG. 12, intra template matching prediction (IntraTMP) is like IBC in that the current CU is also predicted by a block of samples from the current picture. However, unlike IBC, a block vector is not signalled in the bitstream. Instead, decoder 201 compares an L-shaped or other shaped templates of reconstructed samples neighbouring the current CU against L-shaped templates of candidate predictors within a pre-determined search region. The IntraTMP predictor block is determined by finding the best candidate template that matches the current CU template. The best match may be determined by finding the template that minimizes the sum of absolute differences (SAD), or the sum of absolute transformed differences (SATD), or by comparing hashes between templates. The search algorithm through the search region may be exhaustive (for example, by scanning the template over the search region with sample-resolution shifts), or fast (for example, by performing a coarse search first, then performing a local refinement search around the best match from the coarse search). Regardless, the search algorithm may be performed identically by both encoder 101 and decoder 201 so that the IntraTMP predictor is implicitly known by both without signalling in the bitstream. In FIG. 12, the current CU template 1202 and the best matching template 1204 are indicated by hatched shading, while other templates 1206 in the search region are indicated by dashed shading.

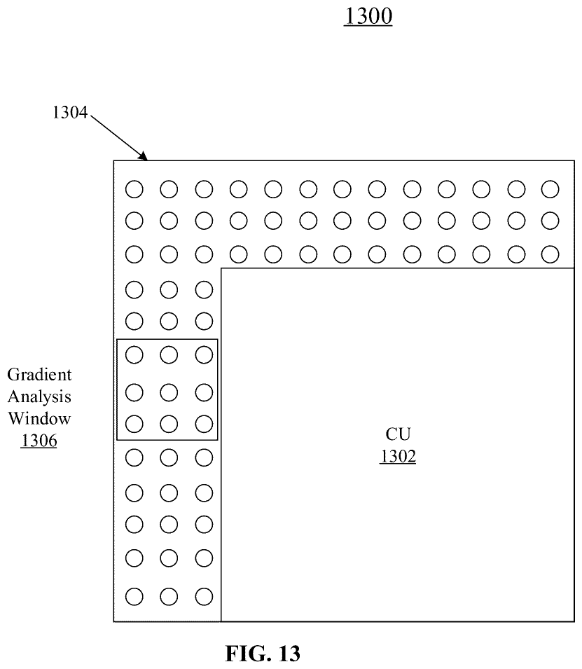

FIG. 13 illustrates a diagram 1300 of a decoder-side intra mode derivation (DIMD) method, according to some embodiments of the present disclosure.

Referring to FIG. 13, in DIMD, an intra prediction mode (or multiple intra prediction modes) is derived implicitly from an L-shaped template 1304 (referred to hereinafter as “template 1304”) of reconstructed samples neighbouring the current CU 1302. The template 1304 has a size of a 3-sample width. Decoder 201 moves a 3×3 gradient analyzing window 1306 over the template 1304. At each position, a local gradient is calculated by applying Sobel filters. Assuming the 3×3 set of samples at one position in the template 1304 is Tₖ, the Sobel filters can be described according to equation (9).

$${M}_{x} = [ \begin{matrix}- 1 & 0 & 1 \\ - 2 & 0 & 2 \\ - 1 & 0 & 1\end{matrix} ] , {M}_{y} = [ \begin{matrix}- 1 & - 2 & - 1 \\ 0 & 0 & 0 \\ 1 & 2 & 1\end{matrix} ] . \qquad ( 9 )$$

Then, the horizontal gradient G_{k,x} and the vertical gradient G_{k,y} are estimated by taking the dot products shown below in equations (10) and (11), respectively.

$${G}_{k , x} = {T}_{k} \cdot {M}_{x} ; and \qquad ( 10 )$$

$${G}_{k , y} = {T}_{k} \cdot {M}_{y} . \qquad ( 11 )$$

The local gradient's magnitude Gₖ and the local gradient's angle θₖ may be estimated according to equations (12) and (13), respectively.

$${G}_{k} = \vert {G}_{k , x} \vert + \vert {G}_{k , y} \vert ; and \qquad ( 12 )$$

$${θ}_{k} = atan ( \frac{{G}_{k , y}}{{G}_{k , x}} ) . \qquad ( 13 )$$

The local gradient's angle θₖ can be associated with an intra angular prediction direction IPMₖ. For example, an angle of 0 degrees corresponds with the horizontal intra prediction mode 18. In practice, IPMₖ may be estimated directly by decoder 201 from G_{k,x} and G_{k,y} with a fast implementation such as a look-up table. At the beginning of the DIMD method, an empty histogram H (populated with zeroes in each entry) is initialized with a size equal to the number of intra prediction modes. As the DIMD method performs gradient analysis over each local window, the histogram H is updated according to equation (14).

$$H [ {IPM}_{k} ] + = {G}_{k} . \qquad ( 14 )$$

Thus, each local gradient analysis “votes” for an intra prediction mode. At the conclusion of the DIMD method, the intra prediction mode with the highest count in H may be selected as the single representative intra prediction mode for the current CU. Alternatively, multiple intra prediction modes may also be obtained from H in order of the highest counts.

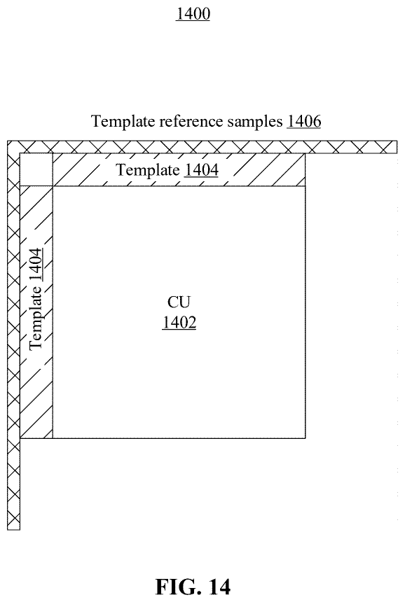

FIG. 14 illustrates a diagram 1400 of a template-based intra mode derivation (TIMD) method, according to some embodiments of the present disclosure. Referring to FIG. 14, in TIMD, an intra prediction mode (or multiple intra prediction modes) is derived implicitly from above and left templates 1404 of reconstructed samples neighbouring the current CU 1402.

A set of candidate intra prediction modes is searched from a most probable modes (MPM) list, which is constructed from intra prediction modes used by neighbouring CUs. Then, for each candidate intra prediction mode, a prediction for template 1404 is produced from the template reference samples 1406 by the intra angular prediction method. The candidate intra prediction mode, which produces a template predictor that best matches template 1404 is selected as the TIMD intra prediction mode. The best match may be determined by finding the predictor that minimizes the sum of absolute differences (SAD), or the sum of absolute transformed differences (SATD), or by comparing hashes between the predictor and the template. Alternatively, multiple intra prediction modes may also be obtained in order of increasing SAD/SATD.

The MIP, IBC, and IntraTMP methods can be effective intra prediction tools. Greater gain may be achieved by enabling combinations of MIP with NSPT and LFNST, IBC with LFNST and NSPT, and IntraTMP with LFNST and NSPT, with intra prediction mode derived as described in the solutions below in connection with FIG. 4.

Transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses fixed probabilities of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 318 may be configured to store the reconstructed block or picture calculated through filter module 316, and the reconstructed and stored block or picture may be provided to inter prediction module 304 when inter prediction is performed.

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure complementary to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, video local-area network (VideoLAN) coding (VLC), context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse DCT, inverse discrete sine transform (DST), inverse KLT, inverse LFNST or inverse NSPT for DCT, DST, KLT, LFNST, or NSPT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT, LFNST, NSPT) according to a plurality of pieces of information such as a prediction method, a size of the current block, a prediction direction, and the like.

In some implementations, whether to apply the LFNST and/or NSPT to transform the residual block may be determined based on intra prediction mode information of a prediction unit used to generate the residual block, as well as indexing in the bitstream. For instance, inverse transform module 406 may use the indexing to select a transform matrix set from among the 3 matrix transform sets mentioned above. Inverse transform module 406 may use the intra prediction mode information to select the transform matrix (from among the 35 transform matrices) from the selected transform matrix set. Various non-limiting examples will not be provided.

For example, in some implementations, inverse transform module 406 may determine that LFNST is enabled for CUs predicted by IBC. Here, inverse transform module 406 may select the LFNST matrix set based on the bitstream index (e.g., 1, 2, or 3), and the LFNST matrix of that set that corresponds to the IBC intra prediction mode. In this and the following examples, an index of 1 may correspond to the first transform matrix set, an index of 2 may correspond to the second transform matrix set, and an index of 3 may correspond to the third transform matrix set.

In some implementations, when LFNST is enabled for CUs predicted by IBC, inverse transform module 406 may select the LFNST matrix set based on the bitstream index, and the LFNST matrix from that set that corresponds to the identified DIMD-derived intra prediction mode.

In some implementations, when LFNST is enabled for CUs predicted by IBC, inverse transform module 406 may select the LFNST matrix set based on the bitstream index, and the LFNST matrix from that set that corresponds to the identified TIMD-derived intra prediction mode.

In some implementations, inverse transform module 406 may determine that NSPT is enabled for CUs predicted by IBC. Here, inverse transform module 406 may select the NSPT matrix set based on the bitstream index (e.g., 1, 2, or 3), and the NSPT matrix of that set that corresponds to IBC.

In some implementations, when NSPT is enabled for CUs predicted by IBC, inverse transform module 406 may select the NSPT matrix set based on the bitstream index, and the NSPT matrix from that set that corresponds to the identified DIMD-derived intra prediction mode.

In some implementations, when NSPT is enabled for CUs predicted by IBC, inverse transform module 406 may select the NSPT matrix set based on the bitstream index, and the NSPT matrix from that set based on the identified TIMD-derived intra prediction mode.

In some implementations, when NSPT is not enabled for CUs predicted by IBC, the NSPT index is not signaled, and inverse transform module 406 may infer the index as 0.

In some implementations, when NSPT is not enabled for CUs predicted by IBC, an index for LFNST may be signaled instead. Here, one of the forgoing implementations for selecting the LFNST matrix may be used by inverse transform module 406.

In some implementations, inverse transform module 406 may determine that LFNST is enabled for CUs predicted by IntraTMP. Here, inverse transform module 406 may select the LFNST matrix set based on the bitstream index (e.g., 1, 2, or 3), and the LFNST matrix of that set that corresponds to the identified IntraTMP intra prediction mode, e.g. planar mode.

In some implementations, when LFNST is enabled for CUs predicted by IntraTMP, inverse transform module 406 may select the LFNST matrix set based on the bitstream index, and the LFNST matrix from that set that corresponds to the identified TIMD-derived intra prediction mode.

In some implementations, when LFNST is not enabled for CUs predicted by IntraTMP, the LFNST index is not included in the bitstream, and inverse transform module 406 may infer the index as 0.

In some implementations, inverse transform module 406 may determine that NSPT is enabled for CUs predicted by IntraTMP. Here, inverse transform module 406 may select the NSPT matrix set based on the bitstream index (e.g., 1, 2, or 3), and the NSPT matrix of that set that corresponds to the identified IntraTMP intra prediction mode, e.g. planar mode.

In some implementations, when NSPT is enabled for CUs predicted by IntraTMP, inverse transform module 406 may select the NSPT matrix set based on the bitstream index, and the NSPT matrix that corresponds to the identified DIMD-derived intra prediction mode.

In some implementations, when NSPT is enabled for CUs predicted by IntraTMP, inverse transform module 406 may select the NSPT matrix set based on the bitstream index, and the NSPT matrix from that set that corresponds to the identified TIMD-derived intra prediction mode.

In some implementations, when NSPT is not enabled for CUs predicted by IntraTMP, the NSPT index is not included in the bitstream, and inverse transform module 406 may infer the index as 0.

In some implementations, when NSPT is not enabled for CUs predicted by IntraTMP, an index for LFNST may be signaled instead. Here, one of the forgoing implementations for selecting the LFNST matrix may be used by inverse transform module 406.

In some implementations, inverse transform module 406 may determine that LFNST is enabled for CUs predicted by MIP. Here, inverse transform module 406 may select the LFNST matrix set based on the bitstream index (e.g., 1, 2, or 3), and the identified TIMD-derived intra prediction mode.

In some implementations, when LFNST is not enabled for CUs predicted by MIP, the LFNST index is not included in the bitstream, and inverse transform module 406 may infer the index as 0.

In some implementations, when NSPT is enabled for CUs predicted by MIP, inverse transform module 406 may select the NSPT matrix set based on the bitstream index, and the NSPT matrix from that set that corresponds to the identified MIP intra prediction mode, e.g. planar mode.

In some implementations, inverse transform module 406 may determine that NSPT is enabled for CUs predicted by MIP. Here, inverse transform module 406 may select the NSPT matrix set based on the bitstream index (e.g., 1, 2, or 3), and the identified MIP intra prediction mode, e.g. planar mode.

In some implementations, when NSPT is enabled for CUs predicted by MIP, inverse transform module 406 may select the NSPT matrix set based on the bitstream index, and the NSPT matrix from that set that corresponds to the identified DIMD-derived intra prediction mode.

In some implementations, when NSPT is enabled for CUs predicted by MIP, inverse transform module 406 may select the NSPT matrix set based on the bitstream index, and the NSPT matrix from that set that corresponds to the identified TIMD-derived intra prediction mode.

In some implementations, when NSPT is not enabled for CUs predicted by MIP, the NSPT index is not included in the bitstream, and inverse transform module 406 may infer the index as 0.

In some implementations, when NSPT is not enabled for CUs predicted by MIP, an index for LFNST may be signaled instead. Here, one of the forgoing implementations for selecting the LFNST matrix may be used by inverse transform module 406.

In some implementations, LFNST and/or NSPT may be enabled for all allowed CU sizes predicted by IBC, IntraTMP, and MIP. Here, the LFNST/NSPT matrix may be selected based on any of the foregoing implementations.

In some implementations, LFNST and NSPT may be enabled for CUs predicted by IBC, IntraTMP, and MIP. Here, inverse transform module 406 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, inverse transform module 406 may determine NSPT will be used; otherwise, LFNST will be used. Similarly, the LFNST/NSPT matrix may selected based on any of the foregoing implementations.

Inter prediction module 408 and intra prediction module 410 may be configured to generate a prediction block based on information related to the generation of a prediction block provided by decoding module 402 and information of a previously decoded block or picture provided by buffer module 414. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

The reconstructed block or reconstructed picture combined from the outputs of inverse transform module 406 and prediction module 408 or 410 may be provided to filter module 412. Filter module 412 may include a deblocking filter, an offset correction module, and an ALF. Buffer module 414 may store the reconstructed picture or block and use it as a reference picture or a reference block for inter prediction module 408 and may output the reconstructed picture.

Consistent with the scope of the present disclosure, encoding module 320 and decoding module 402 may be configured to adopt a scheme of quantization level binarization with Rice parameter adapted to the bit depth and/or the bit rate for encoding the picture of the video to improve the coding efficiency.

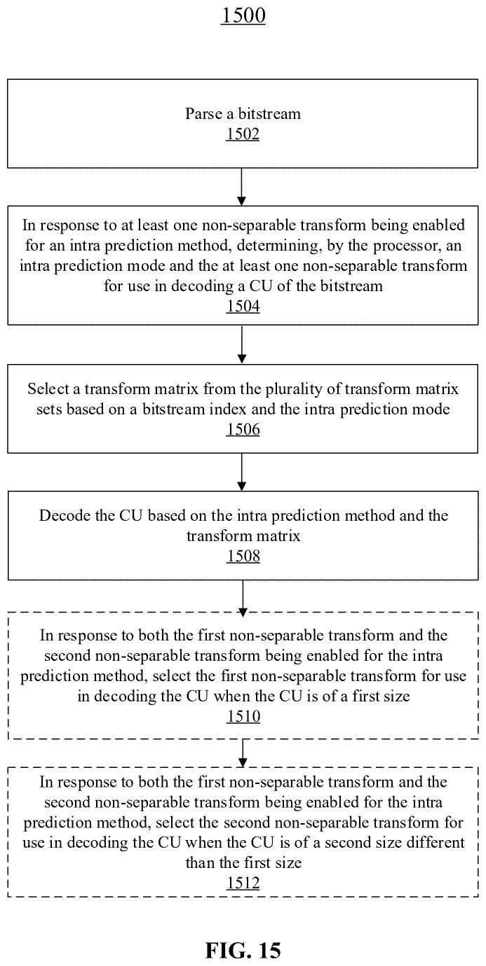

FIG. 15 illustrates a flowchart of an exemplary method 1500 of video decoding, according to some embodiments of the present disclosure. Method 1500 may be performed by a system, e.g., such as decoding system 200, decoder 201, inverse transform module 406, or intra prediction module 410, just to name a few. Method 1500 may include operations 1502-1512, as described below. It is to be appreciated that some of the steps may be optional, and some of the steps may be performed simultaneously, or in a different order than shown in FIG. 15.

Referring to FIG. 15, at 1502, the system may parse a bitstream. For example, referring to FIGS. 2 and 4, decoder 201 may parse a bitstream encoded by encoder 101. By parsing the bitstream, decoder 201 may obtain information that indicates whether LFNST and/or NSPT is enabled for IBC, IntraTMP, and/or MIP.

At 1504, the system may, in response to at least one non-separable transform being enabled for an intra prediction method, determine an intra prediction mode and the at least one non-separable transform for use in decoding a CU of the bitstream. For example, referring to FIGS. 2 and 4, inverse transform module 406 may determine the intra prediction mode and the at least one non-separable transform (e.g., LFNST and/or NSPT) for use in decoding a CU of the bitstream based on the information obtained by parsing the bitstream.

At 1506, the system may select a transform matrix from the plurality of transform matrix sets based on a bitstream index and the intra prediction mode. For example, referring to FIG. 4, in some implementations, inverse transform module 406 may determine that LFNST is enabled for CUs predicted by IBC. Here, inverse transform module 406 may select the LFNST matrix set based on the bitstream index (e.g., 1, 2, or 3), and the LFNST matrix of that set that corresponds to the intra prediction mode. In this and the following examples, an index of 1 may correspond to the first transform matrix set, an index of 2 may correspond to the second transform matrix set, and an index of 3 may correspond to the third transform matrix set. In some implementations, when LFNST is enabled for CUs predicted by IBC, inverse transform module 406 may select the LFNST matrix set based on the bitstream index, and the LFNST matrix from that set that corresponds to the identified DIMD-derived intra prediction mode. In some implementations, when LFNST is enabled for CUs predicted by IBC, inverse transform module 406 may select the LFNST matrix set based on the bitstream index, and the LFNST matrix from that set that corresponds to the identified TIMD-derived intra prediction mode. In some implementations, inverse transform module 406 may determine that NSPT is enabled for CUs predicted by IBC. Here, inverse transform module 406 may select the NSPT matrix set based on the bitstream index (e.g., 1, 2, or 3), and the NSPT matrix of that set that corresponds to IBC. In some implementations, when NSPT is enabled for CUs predicted by IBC, inverse transform module 406 may select the NSPT matrix set based on the bitstream index, and the NSPT matrix from that set that corresponds to the identified DIMD-derived intra prediction mode. In some implementations, when NSPT is enabled for CUs predicted by IBC, inverse transform module 406 may select the NSPT matrix set based on the bitstream index, and the NSPT matrix from that set based on the identified TIMD-derived intra prediction mode. In some implementations, when NSPT is not enabled for CUs predicted by IBC, the NSPT index is not signaled, and inverse transform module 406 may infer the index as 0. In some implementations, when NSPT is not enabled for CUs predicted by IBC, an index for LFNST may be signaled instead. Here, one of the forgoing implementations for selecting the LFNST matrix may be used by inverse transform module 406. In some implementations, inverse transform module 406 may determine that LFNST is enabled for CUs predicted by IntraTMP. Here, inverse transform module 406 may select the LFNST matrix set based on the bitstream index (e.g., 1, 2, or 3), and the LFNST matrix of that set that corresponds to the identified IntraTMP intra prediction mode, e.g. planar mode. In some implementations, when LFNST is enabled for CUs predicted by IntraTMP, inverse transform module 406 may select the LFNST matrix set based on the bitstream index, and the LFNST matrix from that set that corresponds to the identified TIMD-derived intra prediction mode. In some implementations, when LFNST is not enabled for CUs predicted by IntraTMP, the LFNST index is not included in the bitstream, and inverse transform module 406 may infer the index as 0. In some implementations, inverse transform module 406 may determine that NSPT is enabled for CUs predicted by IntraTMP. Here, inverse transform module 406 may select the NSPT matrix set based on the bitstream index (e.g., 1, 2, or 3), and the NSPT matrix of that set that corresponds to the identified IntraTMP intra prediction mode, e.g. planar mode. In some implementations, when NSPT is enabled for CUs predicted by IntraTMP, inverse transform module 406 may select the NSPT matrix set based on the bitstream index, and the NSPT matrix that corresponds to the identified DIMD-derived intra prediction mode. In some implementations, when NSPT is enabled for CUs predicted by IntraTMP, inverse transform module 406 may select the NSPT matrix set based on the bitstream index, and the NSPT matrix from that set that corresponds to the identified TIMD-derived intra prediction mode. In some implementations, when NSPT is not enabled for CUs predicted by IntraTMP, the NSPT index is not included in the bitstream, and inverse transform module 406 may infer the index as 0. In some implementations, when NSPT is not enabled for CUs predicted by IntraTMP, an index for LFNST may be signaled instead. Here, one of the forgoing implementations for selecting the LFNST matrix may be used by inverse transform module 406. In some implementations, inverse transform module 406 may determine that LFNST is enabled for CUs predicted by MIP Here, inverse transform module 406 may select the LFNST matrix set based on the bitstream index (e.g., 1, 2, or 3), and the identified TIMD-derived intra prediction mode. In some implementations, when LFNST is not enabled for CUs predicted by MIP, the LFNST index is not included in the bitstream, and inverse transform module 406 may infer the index as 0. In some implementations, when NSPT is enabled for CUs predicted by MIP, inverse transform module 406 may select the NSPT matrix set based on the bitstream index, and the NSPT matrix from that set that corresponds to the identified MIP intra prediction mode, e.g. planar mode. In some implementations, inverse transform module 406 may determine that NSPT is enabled for CUs predicted by MIP. Here, inverse transform module 406 may select the NSPT matrix set based on the bitstream index (e.g., 1, 2, or 3), and the identified MIP intra prediction mode, e.g. planar mode. In some implementations, when NSPT is enabled for CUs predicted by MIP, inverse transform module 406 may select the NSPT matrix set based on the bitstream index, and the NSPT matrix from that set that corresponds to the identified DIMD-derived intra prediction mode. In some implementations, when NSPT is enabled for CUs predicted by MIP, inverse transform module 406 may select the NSPT matrix set based on the bitstream index, and the NSPT matrix from that set that corresponds to the identified TIMD-derived intra prediction mode. In some implementations, when NSPT is not enabled for CUs predicted by MIP, the NSPT index is not included in the bitstream, and inverse transform module 406 may infer the index as 0. In some implementations, when NSPT is not enabled for CUs predicted by MIP, an index for LFNST may be signaled instead. Here, one of the forgoing implementations for selecting the LFNST matrix may be used by inverse transform module 406. In some implementations, LFNST and/or NSPT may be enabled for CUs predicted by IBC, IntraTMP, and MIP Here, the LFNST/NSPT matrix may be selected based on any of the foregoing implementations. Here, inverse transform module 406 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, inverse transform module 406 may determine NSPT will be used; otherwise, LFNST will be used. Similarly, the LFNST/NSPT matrix may selected based on any of the foregoing implementations.

At 1508, the system may decode the CU based on the intra prediction method and the transform matrix. For example, referring to FIG. 4, based on the intra prediction method and the non-separable transform, decoder 201 may decode a CU.

At 1510, the system may, in response to both the first non-separable transform and the second non-separable transform being enabled for the intra prediction method, select the first non-separable transform for use in decoding the CU when the CU is of a first size. For example, referring to FIG. 4, LFNST and/or NSPT may be enabled for CUs predicted by IBC, IntraTMP, and MIP. Here, inverse transform module 406 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, inverse transform module 406 may determine NSPT will be used; otherwise, LFNST will be used. Similarly, the LFNST/NSPT matrix may selected based on any of the foregoing implementations.

At 1512, the system may, in response to both the first non-separable transform and the second non-separable transform being enabled for the intra prediction method, select the second non-separable transform for use in decoding the CU when the CU is of a second size different than the first size. For example, referring to FIG. 4, LFNST and/or NSPT may be enabled for CUs predicted by IBC, IntraTMP, and MIP. Here, inverse transform module 406 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, inverse transform module 406 may determine NSPT will be used; otherwise, LFNST will be used. Similarly, the LFNST/NSPT matrix may selected based on any of the foregoing implementations.

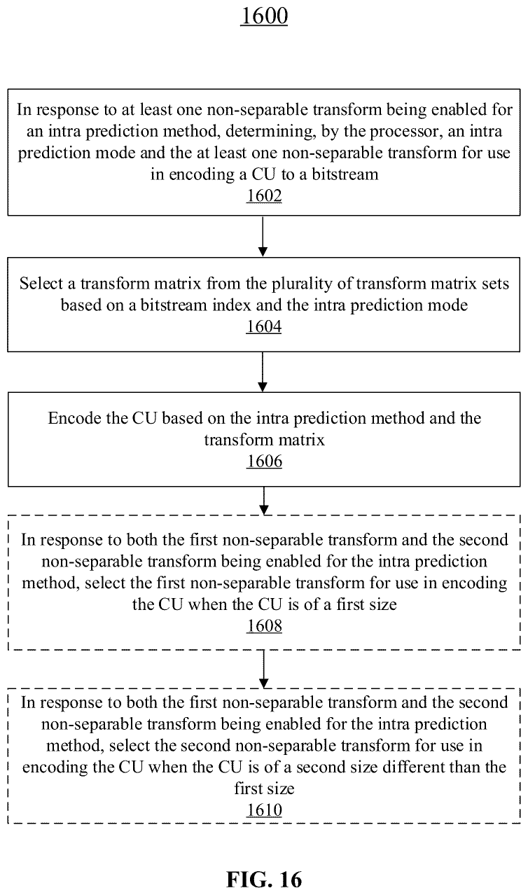

FIG. 16 illustrates a flowchart of an exemplary method 1600 of video encoding, according to some embodiments of the present disclosure. Method 1600 may be performed by a system, e.g., such as encoding system 100, encoder 101, transform module 308, or intra prediction module 306, just to name a few. Method 1600 may include operations 1602-1610, as described below. It is to be appreciated that some of the steps may be optional, and some of the steps may be performed simultaneously, or in a different order than shown in FIG. 16.

Referring to FIG. 16, at 1602, the system may, in response to at least one non-separable transform being enabled for an intra prediction method, determine an intra prediction mode and the at least one non-separable transform for use in encoding a CU of a bitstream. For example, referring to FIGS. 1 and 3, transform module 308 may determine the intra prediction mode and the at least one non-separable transform (e.g., LFNST and/or NSPT) for use in encoding a CU of the bitstream based on a rate-distortion optimization algorithm.

At 1604, the system may select a transform matrix from the plurality of transform matrix sets based on a bitstream index and the intra prediction mode. For example, referring to FIG. 3, in some implementations, transform module 308 may determine that LFNST is enabled for CUs predicted by IBC. Here, transform module 308 may select the LFNST matrix set based on the bitstream index (e.g., 1, 2, or 3), and the LFNST matrix of that set that corresponds to the intra prediction mode. In this and the following examples, an index of 1 may correspond to the first transform matrix set, an index of 2 may correspond to the second transform matrix set, and an index of 3 may correspond to the third transform matrix set. In some implementations, when LFNST is enabled for CUs predicted by IBC, transform module 308 may select the LFNST matrix set based on the bitstream index, and the LFNST matrix from that set that corresponds to the identified DIMD-derived intra prediction mode. In some implementations, when LFNST is enabled for CUs predicted by IBC, transform module 308 may select the LFNST matrix set based on the bitstream index, and the LFNST matrix from that set that corresponds to the identified TIMD-derived intra prediction mode. In some implementations, transform module 308 may determine that NSPT is enabled for CUs predicted by IBC. Here, transform module 308 may select the NSPT matrix set based on the bitstream index (e.g., 1, 2, or 3), and the NSPT matrix of that set that corresponds to IBC. In some implementations, when NSPT is enabled for CUs predicted by IBC, transform module 308 may select the NSPT matrix set based on the bitstream index, and the NSPT matrix from that set that corresponds to the identified DIMD-derived intra prediction mode. In some implementations, when NSPT is enabled for CUs predicted by IBC, transform module 308 may select the NSPT matrix set based on the bitstream index, and the NSPT matrix from that set based on the identified TIMD-derived intra prediction mode. In some implementations, when NSPT is not enabled for CUs predicted by IBC, the NSPT index is not signaled, and transform module 308 may infer the index as 0. In some implementations, when NSPT is not enabled for CUs predicted by IBC, an index for LFNST may be signaled instead. Here, one of the forgoing implementations for selecting the LFNST matrix may be used by transform module 308. In some implementations, transform module 308 may determine that LFNST is enabled for CUs predicted by IntraTMP. Here, transform module 308 may select the LFNST matrix set based on the bitstream index (e.g., 1, 2, or 3), and the LFNST matrix of that set that corresponds to the identified IntraTMP intra prediction mode, e.g. planar mode. In some implementations, when LFNST is enabled for CUs predicted by IntraTMP, transform module 308 may select the LFNST matrix set based on the bitstream index, and the LFNST matrix from that set that corresponds to the identified TIMD-derived intra prediction mode. In some implementations, when LFNST is not enabled for CUs predicted by IntraTMP, the LFNST index is not included in the bitstream, and transform module 308 may infer the index as 0. In some implementations, transform module 308 may determine that NSPT is enabled for CUs predicted by IntraTMP. Here, transform module 308 may select the NSPT matrix set based on the bitstream index (e.g., 1, 2, or 3), and the NSPT matrix of that set that corresponds to the identified IntraTMP intra prediction mode, e.g. planar mode. In some implementations, when NSPT is enabled for CUs predicted by IntraTMP, transform module 308 may select the NSPT matrix set based on the bitstream index, and the NSPT matrix that corresponds to the identified DIMD-derived intra prediction mode. In some implementations, when NSPT is enabled for CUs predicted by IntraTMP, transform module 308 may select the NSPT matrix set based on the bitstream index, and the NSPT matrix from that set that corresponds to the identified TIMD-derived intra prediction mode. In some implementations, when NSPT is not enabled for CUs predicted by IntraTMP, the NSPT index is not included in the bitstream, and transform module 308 may infer the index as 0. In some implementations, when NSPT is not enabled for CUs predicted by IntraTMP, an index for LFNST may be signaled instead. Here, one of the forgoing implementations for selecting the LFNST matrix may be used by transform module 308. In some implementations, transform module 308 may determine that LFNST is enabled for CUs predicted by MIP Here, transform module 308 may select the LFNST matrix set based on the bitstream index (e.g., 1, 2, or 3), and the identified TIMD-derived intra prediction mode. In some implementations, when LFNST is not enabled for CUs predicted by MIP, the LFNST index is not included in the bitstream, and transform module 308 may infer the index as 0. In some implementations, when NSPT is enabled for CUs predicted by MIP, transform module 308 may select the NSPT matrix set based on the bitstream index, and the NSPT matrix from that set that corresponds to the identified MIP intra prediction mode, e.g. planar mode. In some implementations, transform module 308 may determine that NSPT is enabled for CUs predicted by MIP. Here, transform module 308 may select the NSPT matrix set based on the bitstream index (e.g., 1, 2, or 3), and the identified MIP intra prediction mode, e.g. planar mode. In some implementations, when NSPT is enabled for CUs predicted by MIP, transform module 308 may select the NSPT matrix set based on the bitstream index, and the NSPT matrix from that set that corresponds to the identified DIMD-derived intra prediction mode. In some implementations, when NSPT is enabled for CUs predicted by MIP, transform module 308 may select the NSPT matrix set based on the bitstream index, and the NSPT matrix from that set that corresponds to the identified TIMD-derived intra prediction mode. In some implementations, when NSPT is not enabled for CUs predicted by MIP, the NSPT index is not included in the bitstream, and transform module 308 may infer the index as 0. In some implementations, when NSPT is not enabled for CUs predicted by MIP, an index for LFNST may be signaled instead. Here, one of the forgoing implementations for selecting the LFNST matrix may be used by transform module 308. In some implementations, LFNST and/or NSPT may be enabled for CUs predicted by IBC, IntraTMP, and MIP. Here, the LFNST/NSPT matrix may be selected based on any of the foregoing implementations. Here, transform module 308 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, transform module 308 may determine NSPT will be used; otherwise, LFNST will be used. Similarly, the LFNST/NSPT matrix may selected based on any of the foregoing implementations.

At 1606, the system may encode the CU based on the intra prediction method and the transform matrix. For example, referring to FIG. 3, based on the intra prediction method and the non-separable transform, encoder 101 may encode a CU.

At 1608, the system may, in response to both the first non-separable transform and the second non-separable transform being enabled for the intra prediction method, select the first non-separable transform for use in encoding the CU when the CU is of a first size. For example, referring to FIG. 3, LFNST and/or NSPT may be enabled for CUs predicted by IBC, IntraTMP, and MIP. Here, transform module 308 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, transform module 308 may determine NSPT will be used; otherwise, LFNST will be used. Similarly, the LFNST/NSPT matrix may selected based on any of the foregoing implementations.

At 1610, the system may, in response to both the first non-separable transform and the second non-separable transform being enabled for the intra prediction method, select the second non-separable transform for use in encoding the CU when the CU is of a second size different than the first size. For example, referring to FIG. 3, LFNST and/or NSPT may be enabled for CUs predicted by IBC, IntraTMP, and MIP. Here, transform module 308 may determine whether LFNST or NSPT will be used for the current CU based on the size of CU. By way of example and not limitation, if the size of CU is one of 4×4, 4×8, 8×4, 8×8, 4×16, 16×4, 8×16, and 16×8, transform module 308 may determine NSPT will be used; otherwise, LFNST will be used. Similarly, the LFNST/NSPT matrix may selected based on any of the foregoing implementations.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding by a decoder is provided. The method may include parsing, by a processor, a bitstream. The method may include, in response to at least one non-separable transform being enabled for an intra prediction method, determining, by the processor, an intra prediction mode and the at least one non-separable transform for use in decoding a CU of the bitstream. The at least one non-separable transform may be associated with a plurality of transform matrix sets. The method may include selecting, by the processor, a transform matrix from the plurality of transform matrix sets based on a bitstream index and the intra prediction mode. The method may include decoding, by the processor, the CU based on the intra prediction method and the transform matrix. The intra prediction mode may be determined in response to one or more of IBC, matrix MIP, or IntraTMP being used for the CU. The at least one non-separable transform may include one or more of a LFNST or an NSPT.

In some implementations, the selecting, by the processor, the transform matrix from the plurality of transform matrix sets based on the bitstream index and the intra prediction mode may include selecting, by the processor, a transform matrix set from the plurality of transform matrix sets based on the bitstream index. In some implementations, the selecting, by the processor, the transform matrix from the plurality of transform matrix sets based on the bitstream index and the intra prediction mode may include selecting, by the processor, the transform matrix from the transform matrix set based on the intra prediction mode.

In some implementations, the selecting, by the processor, the transform matrix from the transform matrix set based on the intra prediction mode may include selecting, by the processor, the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations, the at least one non-separable transform may include a first non-separable transform and a second non-separable transform.

In some implementations, in response to both the first non-separable transform and the second non-separable transform being enabled for the intra prediction method, the method may further include selecting, by the processor, the first non-separable transform for use in decoding the CU when the CU is of a first size. In some implementations, in response to both the first non-separable transform and the second non-separable transform being enabled for the intra prediction method, the method may further include selecting, by the processor, the second non-separable transform for use in decoding the CU when the CU is of a second size different than the first size.

According to another aspect of the present disclosure, a decoder is provided. The decoder may include a processor and memory storing instructions. The memory storing instructions, when executed by the processor, may cause the processor to parse a bitstream. The memory storing instructions, when executed by the processor, may cause the processor to, in response to at least one non-separable transform being enabled for an intra prediction method, determine an intra prediction mode and the at least one non-separable transform for use in decoding a CU of the bitstream, the at least one non-separable transform being associated with a plurality of transform matrix sets. The memory storing instructions, when executed by the processor, may cause the processor to select a transform matrix from the plurality of transform matrix sets based on a bitstream index and the intra prediction mode. The memory storing instructions, when executed by the processor, may cause the processor to decode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

In some implementations, to select the transform matrix from the plurality of transform matrix sets based on the bitstream index and the intra prediction mode, the memory storing instructions, when executed by the processor, cause the processor to select a transform matrix set from the plurality of transform matrix sets based on the bitstream index. In some implementations, to select the transform matrix from the plurality of transform matrix sets based on the bitstream index and the intra prediction mode, the memory storing instructions, when executed by the processor, cause the processor to select the transform matrix from the transform matrix set based on the intra prediction mode.

In some implementations, to select the transform matrix from the transform matrix set based on the intra prediction mode, the memory storing instructions, when executed by the processor, cause the processor to select the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations the at least one non-separable transform may include a first non-separable transform and a second non-separable transform.

In some implementations, in response to both the first non-separable transform and the second non-separable transform being enabled for the intra prediction method, the memory storing instructions, when executed by the processor, may cause the processor to select the first non-separable transform for use in decoding the CU when the CU is of a first size. In some implementations, in response to both the first non-separable transform and the second non-separable transform being enabled for the intra prediction method, the memory storing instructions, when executed by the processor, may cause the processor to select the second non-separable transform for use in decoding the CU when the CU is of a second size different than the first size.

According to a further aspect of the present disclosure, a non-transitory computer-readable medium storing instructions is provided. The instructions, when executed by the processor, may cause the processor to parse a bitstream. The instructions, when executed by the processor, may cause the processor to, in response to at least one non-separable transform being enabled for an intra prediction method, determine an intra prediction mode and the at least one non-separable transform for use in decoding a CU of the bitstream, the at least one non-separable transform being associated with a plurality of transform matrix sets. The instructions, when executed by the processor, may cause the processor to select a transform matrix from the plurality of transform matrix sets based on a bitstream index and the intra prediction mode. The instructions, when executed by the processor, may cause the processor to decode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

In some implementations, to select the transform matrix from the plurality of transform matrix sets based on the bitstream index and the intra prediction mode, the instructions, when executed by the processor, cause the processor to select a transform matrix set from the plurality of transform matrix sets based on the bitstream index. In some implementations, to select the transform matrix from the plurality of transform matrix sets based on the bitstream index and the intra prediction mode, the instructions, when executed by the processor, cause the processor to select the transform matrix from the transform matrix set based on the intra prediction mode.

In some implementations, to select the transform matrix from the transform matrix set based on the intra prediction mode, the instructions, when executed by the processor, cause the processor to select the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations the at least one non-separable transform may include a first non-separable transform and a second non-separable transform.

In some implementations, in response to both the first non-separable transform and the second non-separable transform being enabled for the intra prediction method, the instructions, when executed by the processor, may cause the processor to select the first non-separable transform for use in decoding the CU when the CU is of a first size. In some implementations, in response to both the first non-separable transform and the second non-separable transform being enabled for the intra prediction method, the instructions, when executed by the processor, may cause the processor to select the second non-separable transform for use in decoding the CU when the CU is of a second size different than the first size.

According to yet another aspect of the present disclosure, a method of encoding by an encoder is provided. The method may include, in response to at least one non-separable transform being enabled for an intra prediction method, determining, by the processor, an intra prediction mode and the at least one non-separable transform for use in encoding a CU to a bitstream, the at least one non-separable transform being associated with a plurality of transform matrix sets. The method may include selecting, by the processor, a transform matrix from the plurality of transform matrix sets based on a bitstream index and the intra prediction mode. The method may include encoding, by the processor, the CU based on the intra prediction method and the transform matrix. The intra prediction mode may be determined in response to one or more of IBC, MIP, or IntraTMP may be used for the CU. The at least one non-separable transform may include one or more of a LFNST or a NSPT.

In some implementations the selecting, by the processor, the transform matrix from the plurality of transform matrix sets based on the bitstream index and the intra prediction mode may include selecting, by the processor, a transform matrix set from the plurality of transform matrix sets based on the bitstream index. In some implementations the selecting, by the processor, the transform matrix from the plurality of transform matrix sets based on the bitstream index and the intra prediction mode may include selecting, by the processor, the transform matrix from the transform matrix set based on the intra prediction mode.

In some implementations, the selecting, by the processor, the transform matrix from the transform matrix set based on the intra prediction mode may include selecting, by the processor, the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations, the at least one non-separable transform may include a first non-separable transform and a second non-separable transform.

In some implementations, in response to both the first non-separable transform and the second non-separable transform being enabled for the intra prediction method, the method may include selecting, by the processor, the first non-separable transform for use in encoding the CU when the CU is of a first size. In some implementations, in response to both the first non-separable transform and the second non-separable transform being enabled for the intra prediction method, the method may include selecting, by the processor, the second non-separable transform for use in encoding the CU when the CU is of a second size different than the first size.

According to yet a further aspect of the present disclosure, an encoder is provided. The encoder may include a processor and memory storing instructions. The memory storing instructions, when executed by the processor, cause the processor to, in response to at least one non-separable transform being enabled for an intra prediction method, determine an intra prediction mode and the at least one non-separable transform for use in encoding a CU to a bitstream. The at least one non-separable transform may be associated with a plurality of transform matrix sets. The memory storing instructions, when executed by the processor, cause the processor to select a transform matrix from the plurality of transform matrix sets based on a bitstream index and the intra prediction mode. The memory storing instructions, when executed by the processor, cause the processor to encode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

In some implementations, to select the transform matrix from the plurality of transform matrix sets based on the bitstream index and the intra prediction mode, the memory storing instructions, when executed by the processor, may cause the processor to select a transform matrix set from the plurality of transform matrix sets based on the bitstream index. In some implementations, to select the transform matrix from the plurality of transform matrix sets based on the bitstream index and the intra prediction mode, the memory storing instructions, when executed by the processor, may cause the processor to select the transform matrix from the transform matrix set based on the intra prediction mode.

In some implementations, to select the transform matrix from the transform matrix set based on the intra prediction mode, the memory storing instructions, when executed by the processor, may cause the processor to select the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations, the at least one non-separable transform may include a first non-separable transform and a second non-separable transform.

In some implementations, in response to both the first non-separable transform and the second non-separable transform being enabled for the intra prediction method, the memory storing instructions, when executed by the processor, may cause the processor to select the first non-separable transform for use in encoding the CU when the CU is of a first size. In some implementations, in response to both the first non-separable transform and the second non-separable transform being enabled for the intra prediction method, the memory storing instructions, when executed by the processor, may cause the processor to select the second non-separable transform for use in encoding the CU when the CU is of a second size different than the first size.

According to still another aspect of the present disclosure, a non-transitory computer-readable medium storing instructions is provided. The instructions, when executed by the processor, cause the processor to, in response to at least one non-separable transform being enabled for an intra prediction method, determine an intra prediction mode and the at least one non-separable transform for use in encoding a CU to a bitstream. The at least one non-separable transform may be associated with a plurality of transform matrix sets. The instructions, when executed by the processor, cause the processor to select a transform matrix from the plurality of transform matrix sets based on a bitstream index and the intra prediction mode. The instructions, when executed by the processor, cause the processor to encode the CU based on the intra prediction method and the transform matrix. The intra prediction mode may be determined in response to one or more of IBC, MIP, or IntraTMP being used for the CU. The at least one non-separable transform may include one or more of a LFNST or a NSPT.

In some implementations, to select the transform matrix from the plurality of transform matrix sets based on the bitstream index and the intra prediction mode, the instructions, when executed by the processor, may cause the processor to select a transform matrix set from the plurality of transform matrix sets based on the bitstream index. In some implementations, to select the transform matrix from the plurality of transform matrix sets based on the bitstream index and the intra prediction mode, the instructions, when executed by the processor, may cause the processor to select the transform matrix from the transform matrix set based on the intra prediction mode.

In some implementations, to select the transform matrix from the transform matrix set based on the intra prediction mode, the instructions, when executed by the processor, may cause the processor to select the transform matrix from the transform matrix set based on an intra prediction mode derived by a DIMD or a TIMD.

In some implementations, when the at least one non-separable transform is not enabled for the intra prediction method, the bitstream index may be omitted from the bitstream.

In some implementations, the at least one non-separable transform may be enabled for CUs of any size.

In some implementations, the at least one non-separable transform may include a first non-separable transform and a second non-separable transform.

In some implementations, in response to both the first non-separable transform and the second non-separable transform being enabled for the intra prediction method, the instructions, when executed by the processor, may cause the processor to select the first non-separable transform for use in encoding the CU when the CU is of a first size. In some implementations, in response to both the first non-separable transform and the second non-separable transform being enabled for the intra prediction method, the instructions, when executed by the processor, may cause the processor to select the second non-separable transform for use in encoding the CU when the CU is of a second size different than the first size.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
parsing, by a processor, a bitstream;
in response to at least one non-separable transform being enabled for an intra prediction method, determining, by the processor, an intra prediction mode and the at least one non-separable transform for use in decoding a coding unit (CU) of the bitstream, the at least one non-separable transform being associated with a plurality of transform matrix sets;
selecting, by the processor, a transform matrix from the plurality of transform matrix sets based on a bitstream index and the intra prediction mode; and
decoding, by the processor, the CU based on the intra prediction method and the transform matrix,
wherein the intra prediction mode is determined in response to one or more of intra block copy (IBC), matrix weighted intra prediction (MIP), or intra template matching prediction (IntraTMP) being used for the CU, and
wherein the at least one non-separable transform includes one or more of a low frequency non-separable secondary transform (LFNST) or a non-separable primary transform (NSPT).

2. The method of claim 1, wherein the selecting, by the processor, the transform matrix from the plurality of transform matrix sets based on the bitstream index and the intra prediction mode comprises:
selecting, by the processor, a transform matrix set from the plurality of transform matrix sets based on the bitstream index; and
selecting, by the processor, the transform matrix from the transform matrix set based on the intra prediction mode.

3. The method of claim 2, wherein the selecting, by the processor, the transform matrix from the transform matrix set based on the intra prediction mode comprises:
selecting, by the processor, the transform matrix from the transform matrix set based on an intra prediction mode derived by a decoder-side intra mode derivation (DIMD) or a template-based intra mode derivation (TIMD).

4. The method of claim 1, wherein, when the at least one non-separable transform is not enabled for the intra prediction method, the bitstream index is omitted from the bitstream.

5. The method of claim 1, wherein the at least one non-separable transform is enabled for coding units (CUs) of any size.

6. The method of claim 1, wherein the at least one non-separable transform includes a first non-separable transform and a second non-separable transform.

7. The method of claim 6, wherein, in response to both the first non-separable transform and the second non-separable transform enabled for with the intra prediction method, the method further comprises:
selecting, by the processor, the first non-separable transform for use in decoding the CU when the CU is of a first size; or
selecting, by the processor, the second non-separable transform for use in decoding the CU when the CU is of a second size different than the first size.

8-21. (canceled)

22. A method of encoding by an encoder, comprising:
in response to at least one non-separable transform being enabled for an intra prediction method, determining, by the processor, an intra prediction mode and the at least one non-separable transform for use in encoding a coding unit (CU) to a bitstream, the at least one non-separable transform being associated with a plurality of transform matrix sets;
selecting, by the processor, a transform matrix from the plurality of transform matrix sets based on a bitstream index and the intra prediction mode; and
encoding, by the processor, the CU based on the intra prediction mode and the transform matrix,
wherein the intra prediction mode is determined in response to one or more of intra block copy (IBC), matrix weighted intra prediction (MIP), or intra template matching prediction (IntraTMP) being used for the CU, and
wherein the at least one non-separable transform includes one or more of a low frequency non-separable secondary transform (LFNST) or a non-separable primary transform (NSPT).

23. The method of claim 22, wherein the selecting, by the processor, the transform matrix from the plurality of transform matrix sets based on the bitstream index and the intra prediction mode comprises:
selecting, by the processor, a transform matrix set from the plurality of transform matrix sets based on the bitstream index; and
selecting, by the processor, the transform matrix from the transform matrix set based on the intra prediction mode.

24. The method of claim 23, wherein the selecting, by the processor, the transform matrix from the transform matrix set based on the intra prediction mode comprises:
selecting, by the processor, the transform matrix from the transform matrix set based on an intra prediction mode derived by a decoder-side intra mode derivation (DIMD) or a template-based intra mode derivation (TIMD).

25. The method of claim 22, wherein, when the at least one non-separable transform is not enabled for the intra prediction method, the bitstream index is omitted from the bitstream.

26. The method of claim 22, wherein the at least one non-separable transform is enabled for coding units (CUs) of any size.

27. The method of claim 22, wherein the at least one non-separable transform includes a first non-separable transform and a second non-separable transform.

28. The method of claim 27, wherein, in response to both the first non-separable transform and the second non-separable transform being enabled for the intra prediction method, the method further comprises:
selecting, by the processor, the first non-separable transform for use in encoding the CU when the CU is of a first size; or
selecting, by the processor, the second non-separable transform for use in encoding the CU when the CU is of a second size different than the first size.

29-35. (canceled)

36. A non-transitory computer-readable medium storing instructions, when executed by a processor, cause the processor to perform the following operations to generate a bitstream and store the bitstream:
in response to at least one non-separable transform being enabled for an intra prediction method, determine an intra prediction mode and the at least one non-separable transform for use in encoding a coding unit (CU) to the bitstream, the at least one non-separable transform being associated with a plurality of transform matrix sets;
select a transform matrix from the plurality of transform matrix sets based on a bitstream index and the intra prediction mode; and
encode the CU based on the intra prediction method and the transform matrix,
wherein the intra prediction mode is determined in response to one or more of intra block copy (IBC), matrix weighted intra prediction (MIP), or intra template matching prediction (IntraTMP) being used for the CU, and
wherein the at least one non-separable transform includes one or more of a low frequency non-separable secondary transform (LFNST) or a non-separable primary transform (NSPT).

37. The non-transitory computer-readable medium of claim 36, wherein, to select the transform matrix from the plurality of transform matrix sets based on the bitstream index and the intra prediction mode, the instructions, when executed by the processor, cause the processor to:
select a transform matrix set from the plurality of transform matrix sets based on the bitstream index; and
select the transform matrix from the transform matrix set based on the intra prediction mode.

38. The non-transitory computer-readable medium of claim 37, wherein, to select the transform matrix from the transform matrix set based on the intra prediction mode, the instructions, when executed by the processor, cause the processor to:
select the transform matrix from the transform matrix set based on an intra prediction mode derived by a decoder-side intra mode derivation (DIMD) or a template-based intra mode derivation (TIMD).

39. The non-transitory computer-readable medium of claim 36, wherein, when the at least one non-separable transform is not enabled for the intra prediction method, the bitstream index is omitted from the bitstream.

40. The non-transitory computer-readable medium of claim 36, wherein the at least one non-separable transform is enabled for coding units (CUs) of any size.

41. The non-transitory computer-readable medium of claim 36, wherein the at least one non-separable transform includes a first non-separable transform and a second non-separable transform.

42. (canceled)
